(19) United States
(12) Patent Application Publication
(10) Pub. No.: US 2007/0058285 A1
(43) Pub. Date: Mar. 15, 2007

(54) Media cartridge autoloader

(76) Inventor: Hiromi Tanaka, Tokyo (JP)

Correspondence Address: Eugene Lieberstein;ANDERSON KILL & OLICK, P.C., 1251 Avenue of the Americas, New York, NY, 10020, US

(21) Appl. No.: 11/283,122

(22) Filed: Nov. 18, 2005

(30) Foreign Application Priority Data
Sep. 14, 2005 (JP) 2005-267533

(51) Int. Cl. G11B 15/68

(52) U.S. Cl. 360/92

(57) ABSTRACT

A media cartridge autoloader including a mis-loading inhibitor is disclosed. The mis-loading inhibitor prevents media cartridge transport magazines each containing media cartridges whose recording systems are different from being mis-loaded and includes mis-loading inhibitor members secured to a frame and lid members attached to the media cartridge transport magazines. The mis-loading inhibitor changes the directions of the mis-loading inhibitor members and the lid members corresponding to the types of the media cartridges. The media cartridge transport magazine can correspond to any type of media cartridge by changing the attaching directions of the mis-loading inhibitor members and the lid members.

### BACKGROUND OF THE INVENTION

1. Field of the Invention

The present invention relates to a media cartridge autoloader, particularly relates to a mechanism that selectively moves either one of first or second media cartridge transport magazines in a media cartridge autoloader serving as a data storage device, and more particularly relates to a mis-loading inhibitor that inhibits or prevents a media cartridge transport magazine from being mis-loaded in the media cartridge autoloader.

2. Description of the Related Art

A typical media cartridge autoloader includes a media cartridge picker in the center, a mail slot at the front side, a read/write media drive at the rear side, and media cartridge transport magazines disposed one at each lateral side.

The media cartridge picker is configured to transport a media cartridge among the mail slot, the media drive, and the media cartridge transport magazines, by picking the media cartridge and sending it.

Each media cartridge transport magazine comprises a plurality of media cartridge storage cases along a loop belt so as to store the media cartridges therein. The loop belt is driven such that a selected one of the media cartridge storage cases is moved next to the media cartridge picker.

To store many media cartridges, the media cartridge transport magazines are provided at the left and right sides. In addition, the media cartridges can have plural types whose shapes and sizes are different due to the recording systems. One of the recording systems can be selected based on the demand of a user, and plural types of media cartridge transport magazines are provided so that the user can select one. Because each media cartridge transport magazine is manufactured corresponding to the type of the media cartridge used therein, the manufacturing cost of the media cartridge autoloader may be higher than desired.

### SUMMARY OF THE INVENTION

The present invention is directed toward a media cartridge autoloader that includes a media cartridge transport magazine which contains plural media cartridges, a frame which holds the media cartridge transport magazine, and a media drive into which an arbitrary media cartridge, which is picked from the plural media cartridges being contained in the media cartridge transport magazine, is moved and loaded. In the media cartridge autoloader, a lid member having a shape corresponding to the type of the media cartridge is changeably attached to the end of the media cartridge transport magazine, and a mis-loading inhibitor member having a shape corresponding to the lid member is changeably attached to the frame.

According to a second aspect of the present invention, the lid member includes a fitting section at a position corresponding to the type of the media cartridge, and the mis-loading inhibitor member includes a section to be fitted into the fitting section at a position corresponding to the position of the fitting section.

According to a third aspect of the present invention, the lid member includes plural fitting sections, and the positions of the fitting sections opposing the mis-loading inhibitor member are changed by changing the direction for attaching the lid member to the media cartridge transport magazine.

According to a fourth aspect of the present invention, the mis-loading inhibitor member includes plural sections to be fitted into the fitting sections, and the positions of the sections to be fitted into opposing the lid member are changed by changing the direction for attaching the mis-loading inhibitor member to the frame.

According to a fifth aspect of the present invention, the mis-loading inhibitor member includes a first section to be fitted into the fitting section, a second section that moves by being pressed by the lid member, and a moving member that moves the second section in the direction opposite to the inserting direction of the tape cartridge transport magazine.

According to a sixth aspect of the present invention, the mis-loading inhibitor includes a detecting unit that detects that the second section is moved by being pressed by the lid member.

According to a seventh aspect of the present invention, the detecting unit detects that the type of the media cartridge transport magazine is normal when the second section is pressed by the lid member, and detects that the type of the media cartridge transport magazine is abnormal when the second section is not pressed by the lid member.

According to another embodiment of the present invention, since a lid member having a shape corresponding to the type of the media cartridge is changeably attached to the end of the media cartridge transport magazine, and a mis-loading inhibitor member having a shape corresponding to the lid member is changeably attached to the frame, there is no need to manufacture media cartridge transport magazines corresponding to different types of the media cartridges, and the media cartridge transport magazine can be common among the media cartridges whose types are different.

According to yet another embodiment of the present invention, since the lid member includes a fitting section at a position corresponding to the type of the media cartridge, and the mis-loading inhibitor member includes a section to be fitted into the fitting section at a position corresponding to the position of the fitting section, a media cartridge transport magazine whose type is different can be inhibited or prevented from being loaded. When the type of the media cartridge contained in the media cartridge transport magazine matches the type of the frame, the media cartridge transport magazine can be loaded in the frame, and mis-loading can be inhibited or prevented.

According to still another embodiment of the present invention, since the lid member includes plural fitting sections, and the positions of the fitting sections opposing the mis-loading inhibitor member are changed by changing the direction for attaching the lid member to the media cartridge transport magazine, the attaching direction of the lid member is changed corresponding to the type of the media cartridge; thus, the lid member can be common.

According to another embodiment of the present invention, since the mis-loading inhibitor member includes plural sections to be fitted into the fitting sections, and the positions of the sections to be fitted into opposing the lid member are changed by changing the direction for attaching the mis-loading inhibitor member to the frame, the attaching direction of the mis-loading inhibitor member is changed corresponding to the type of the media cartridge; thus, the mis-loading inhibitor member can be common.

In yet another embodiment of the present invention, since the mis-loading inhibitor member includes a first section to be fitted into the fitting section, a second section that moves by being pressed by the lid member, and a moving member that moves the second section in the direction opposite to the inserting direction of the media cartridge transport magazine, when the media cartridge transport magazine is ejected, the media cartridge transport magazine can be ejected in the ejecting direction by a moving force of the moving member.

In still another embodiment of the present invention, since the mis-loading inhibitor member includes a detecting unit for detecting that the second section is moved by being pressed by the lid member, the detecting unit detects that the type of the media cartridge transport magazine is normal when the second section is pressed by the lid member, and detects that the type of the media cartridge transport magazine is abnormal when the second section is not pressed by the lid member, the loading state of the media cartridge transport magazine can be recognized.

### BRIEF DESCRIPTION OF THE DRAWINGS

FIG. 1 is a perspective view illustrating a media cartridge autoloader with an upper cover thereof removed according to a first embodiment of the present invention;

FIG. 2 is a side view illustrating the media cartridge autoloader of FIG. 1 with a side cover thereof removed;

FIG. 3 is a schematic illustration showing operations of a media cartridge picker;

FIG. 4 is a perspective view illustrating a main module;

FIG. 5 is an exploded view illustrating the main module;

FIG. 6 is a perspective view of the main module, viewed from a Y1 side;

FIG. 7 is a perspective view illustrating the media cartridge picker;

FIG. 8 is a perspective view illustrating the media cartridge picker with a pillar and a turntable removed;

FIG. 9 is an exploded perspective view illustrating the media cartridge picker;

FIG. 10 is an exploded perspective view illustrating a turntable lifting mechanism in detail;

FIG. 11 is a perspective view illustrating the turntable;

FIG. 12 is a schematic illustration showing a media cartridge transport mechanism;

FIG. 13 is a perspective view of the main module with the media cartridge picker, a mail slot module, and a motor module removed, viewed from a Y2 side;

FIG. 14 is a perspective view of the main module of FIG. 13, viewed from the Y1 side;

FIG. 15 is a perspective view of a Y2 -side part of the main module with the mail slot module removed, viewed obliquely from an X2 side;

FIG. 16 is a perspective view illustrating a media cartridge transport magazine drive with a drive shaft unit located at a home position;

FIG. 17 is a perspective view showing an X1-side portion of the Y2-side part of the main module with the mail slot module removed;

FIG. 18 is a perspective view of the Y2-side part of the main module, viewed obliquely from an X1 side;

FIG. 19 is an enlarged perspective view showing a drive gear and a positioning pin disposed at the X2 side;

FIG. 20 shows a photo sensor for detecting the rotation angle of the turntable;

FIG. 21 is a perspective view of the media cartridge transport magazine with an X2 -side lateral plate removed, viewed from the X2 side;

FIG. 22 is a perspective view of the media cartridge transport magazine of FIG. 21, viewed from the X1 side;

FIG. 23 is an enlarged view illustrating a part of the media cartridge transport magazine of FIG. 22;

FIG. 24A illustrates the media cartridge transport magazine drive in its initial state;

FIG. 24B illustrates the media cartridge transport magazine drive in a state to drive an X2-side magazine;

FIG. 24C illustrates the media cartridge transport magazine drive in a state to drive an X1-side magazine;

FIG. 25 illustrates an X2-side part of the drive shaft unit opposing a magazine in the initial state;

FIG. 26 illustrates the X2-side part of the drive shaft unit in a process of being coupled with the magazine;

FIG. 27 illustrates the X2-side part of the drive shaft unit coupled with the magazine;

FIGS. 28A-28D illustrate operations for correcting a center distance between a drive gear and a magazine gear;

FIGS. 29A-29D illustrate operations to be performed when tooth sections of the drive gear contact and interfere with tooth sections of the magazine gear;

FIG. 30 is a flowchart illustrating operations of a microcomputer of a motor control circuit;

FIG. 31 is a plan view illustrating a mis-loading inhibitor for preventing the media cartridge transport magazines from being mis-loaded;

FIG. 32 is a plan view illustrating another mis-loading inhibitor for preventing the media cartridge transport magazines from being mis-loaded;

FIG. 33 is a plan view enlarging an upper rear part of a frame before a mis-loading inhibitor member is attached;

FIGS. 34A-34D illustrate a configuration of the mis-loading inhibitor member;

FIGS. 35A-35D illustrate a configuration of a second convex section;

FIG. 36 is a side view illustrating an inner side of the media cartridge transport magazine;

FIG. 37 is a side view illustrating an outer side of the media cartridge transport magazine;

FIGS. 38A-38B illustrate directions of a lid member when a media cartridge being an A type is used;

FIGS. 39A-39B illustrate directions of the lid member when a media cartridge being a B type is used; and

FIG. 40 illustrates a fitting state between the mis-loading inhibitor member and the lid member.

### DETAILED DESCRIPTION OF THE PREFERRED EMBODIMENT

An exemplary embodiment of the present invention is described hereinafter with reference to the accompanying drawings.

### First Embodiment

The description of a first embodiment includes the following:

1. Configuration and Operations Overview of Media Cartridge Autoloader 100

2. Configuration of Main Module 110

3. Configuration and Operations of Tape Cartridge Picker 102

4. Configuration of Tape Cartridge Transport Magazine Drive 300
4-1. Configuration of Drive Shaft Unit 301
4-2. Configuration of Drive Shaft Unit Shift Mechanism 320
4-3. Configuration of Magazine Drive Motor Module 330

5. Configuration of Tape Cartridge Transport Magazines 103, 104

6. Operations for Selectively Driving Tape Cartridge Transport Magazines 103, 104

7. Operations of Microcomputer of Motor Control Circuit 410

8. Configuration and Operations of Mis-loading Inhibitor of Tape Cartridge Transport Magazines 103, 104

1 [Configuration and Operations Overview of Tape Cartridge Autoloader 100]

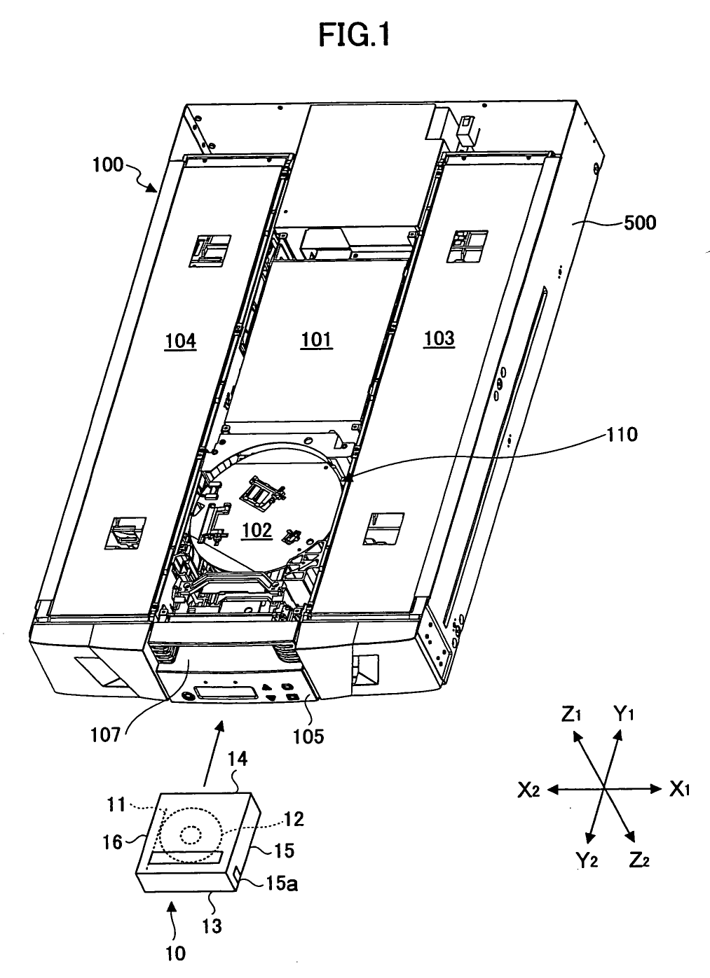

FIG. 1 is a perspective view illustrating a media cartridge autoloader 100 with an upper cover thereof removed according to the first embodiment of the present invention. In the embodiments illustrated in the figures, the media cartridge autoloader is used with one or more tape cartridges, and is therefore referred to hereinafter as a tape cartridge autoloader. It is recognized, however, that although the following description and the figures provided herein pertain particularly to an autoloader used for tape cartridges, any other suitable type of media cartridge can equally be used with the present invention, such as an optical disk cartridge, as one non-exclusive example. The embodiments disclosed herein are not intended to limit the scope of the present invention in any manner to use with tape cartridges or any other particular type of, media. In other words, it is understood that the term “tape” as used herein can equally be substituted for the term “media”.

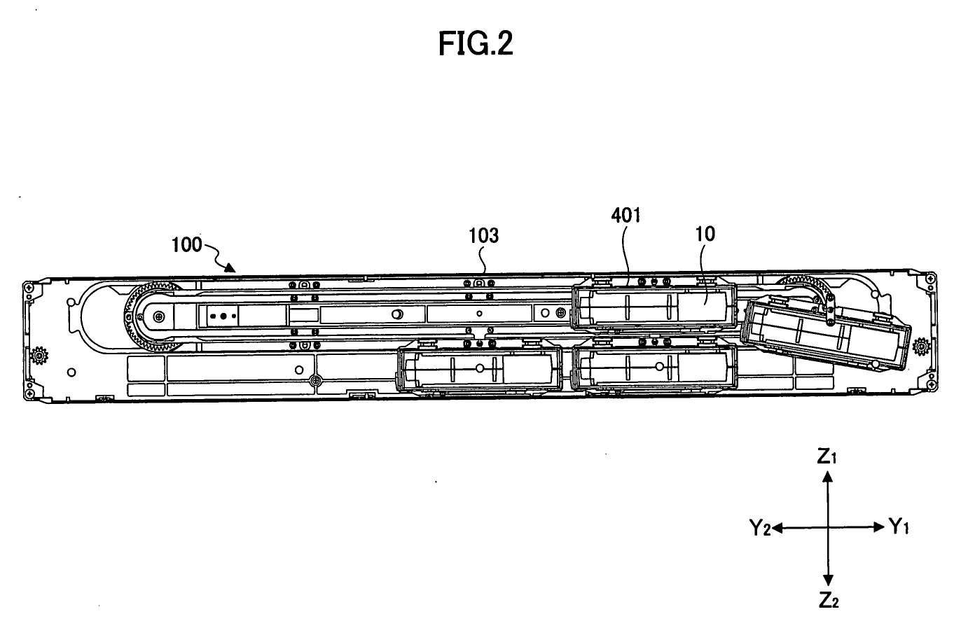

FIG. 2 is a side view illustrating the tape cartridge autoloader 100 with a side cover thereof removed. Throughout the drawings, the width direction is indicated by a line X1-X2, the depth direction is indicated by a line Y1-Y2, and the height direction is indicated by a line Z1-Z2.

In one embodiment, the tape cartridge autoloader 100 generally comprises a metal frame 500, a control panel 105 and a mail slot 107 both on a front panel, a main module 110 including a tape cartridge picker 102 at a position near and/or opposing the mail slot 107, a tape drive 101 disposed at the Y1 side of the main module 110, and first and second tape cartridge transport magazines 103 and 104 disposed one at the X1 side and the X2 side of the main module 110. In this embodiment, the tape cartridge transport magazines 103 and 104 can be inserted toward the Y1 side from the front panel side and removably attached on opposing sides of the frame 500. In an alternative embodiment, the tape cartridge transport magazines 103, 104 can be positioned to have a different orientation relative to one another and/or to the main module 110. In one non-exclusive alternative embodiment, for example, although the tape cartridge transport magazines 103, 104 are shown to be generally parallel to one another in FIG. 1, they can be positioned in a substantially non-parallel orientation. It is understood that as used herein, either tape cartridge transport magazine 103, 104 can be the first tape cartridge transport magazine or the second tape cartridge transport magazine. The tape cartridge autoloader 100 can be mounted in a rack by, for example, fixing four corners of the frame 500 to poles of the rack.

In certain embodiments, the tape cartridge autoloader 100 is designed such that operations of the tape cartridge picker 102 and operations of the tape cartridge transport magazines 103 and 104 do not overlap in terms of time.

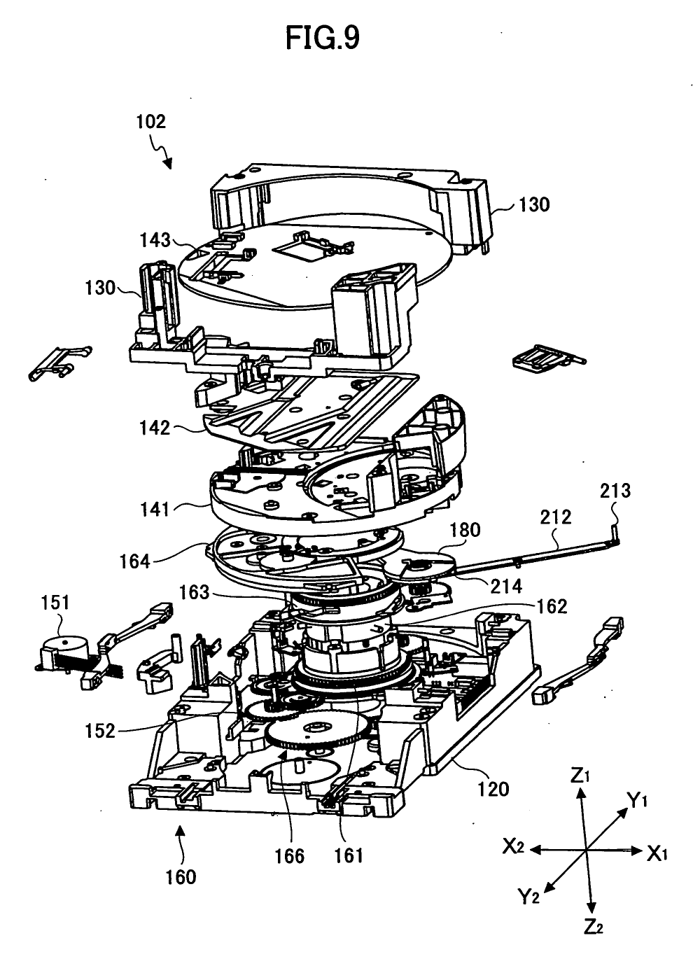

A tape cartridge 10 is used in the tape cartridge autoloader 100. Referring to FIG. 1, the tape cartridge 10 includes a magnetic tape 11 wound on a single reel 12 therein such that the magnetic tape 11 is pulled out from a rear face of the tape cartridge 10. The tape cartridge 10 includes a front face 13, a rear face 14, side faces 15 and 16, and a notch 15a formed on the side face 15 which a cartridge pin 213 (FIG. 9, for example, described below) engages.

The tape cartridge transport magazines 103 and 104 are each configured to store plural tape cartridges 10 orienting the front faces 13 to face the tape cartridge picker 102. The tape cartridge transport magazines 103 and 104 are also configured to transport the tape cartridges 10 along a racetrack path elongated in the Y1-Y2 direction, as illustrated in FIG. 2.

The tape drive 101 is operable to read and/or write data from or to the magnetic tape 11 pulled out from the loaded tape cartridge 10. The tape drive 101 includes a tape cartridge eject mechanism (not shown). Plural types of tape drives with different heights are available so that one drive is selected from them and attached to the tape cartridge autoloader 100. For this operation, the tape cartridge picker 102 is provided with a turntable lifting mechanism 150 (described below).

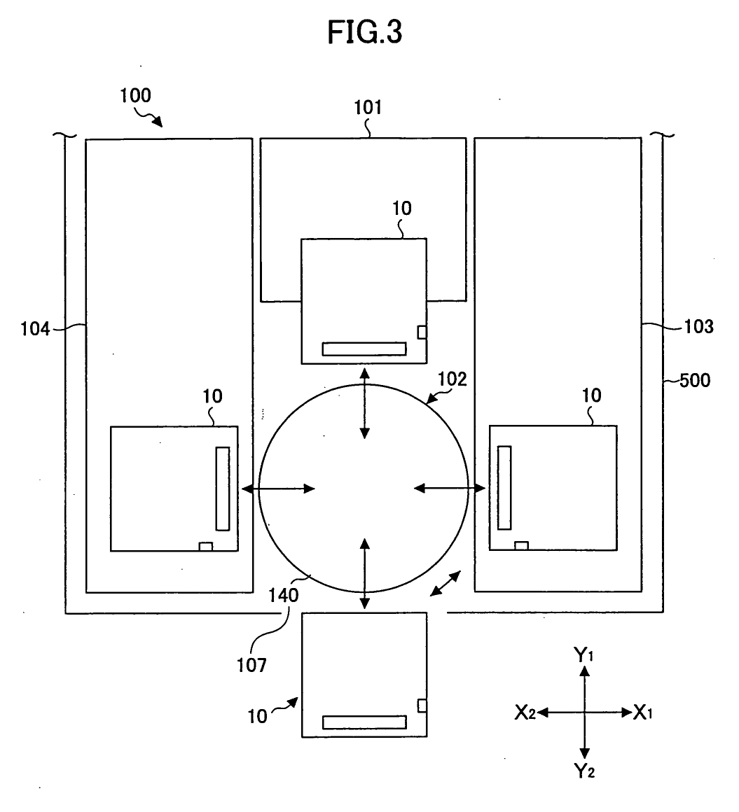

Referring to FIG. 3, the tape cartridge picker 102 is configured to transport the tape cartridge 10 onto or off of a turntable 140 for operations such as loading the tape cartridge 10 inserted through the mail slot 107 into the tape drive 101, retrieving the tape cartridge 10 from the tape cartridge transport magazine 103 or 104 to load the tape cartridge 10 onto the tape drive 101, retrieving the tape cartridge 10 from the tape drive 101 to return the tape cartridge 10 to the tape cartridge transport magazine 103 or 104, and ejecting the tape cartridge 10 through the mail slot 107. The tape cartridge picker 102 is also configured to rotate the turntable 140 by a predetermined rotational increment, such as by approximately 90-degree increments, although the rotational increment can vary depending upon the design requirements of the autoloader 100. The tape cartridge picker 102 can also raise/lower the turntable 140. When the turntable 140 is rotated, the orientation of the tape cartridge 10 is changed.

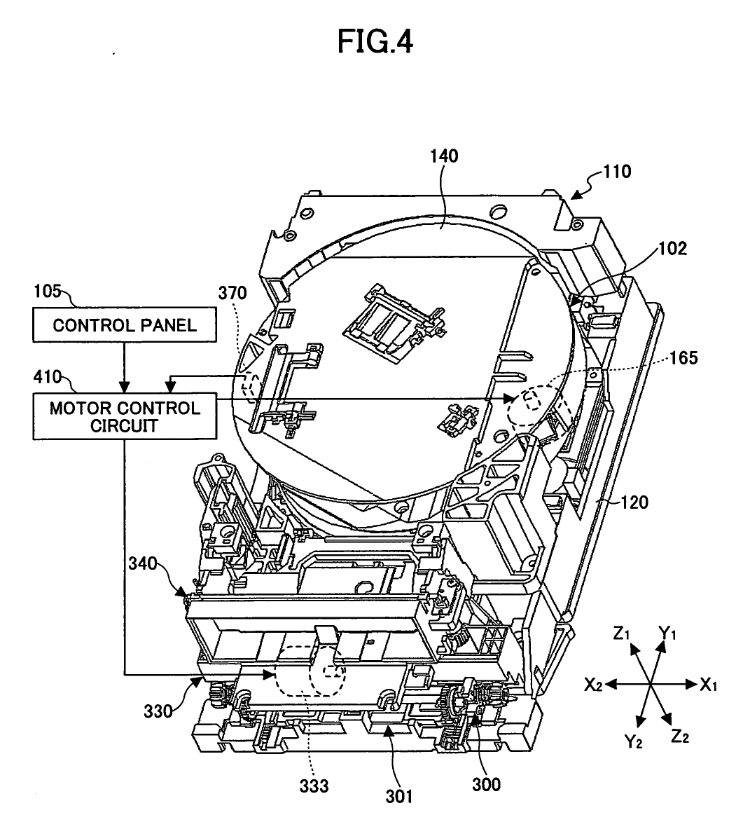

2 [Configuration of Main Module 110] (FIGS. 4-6)

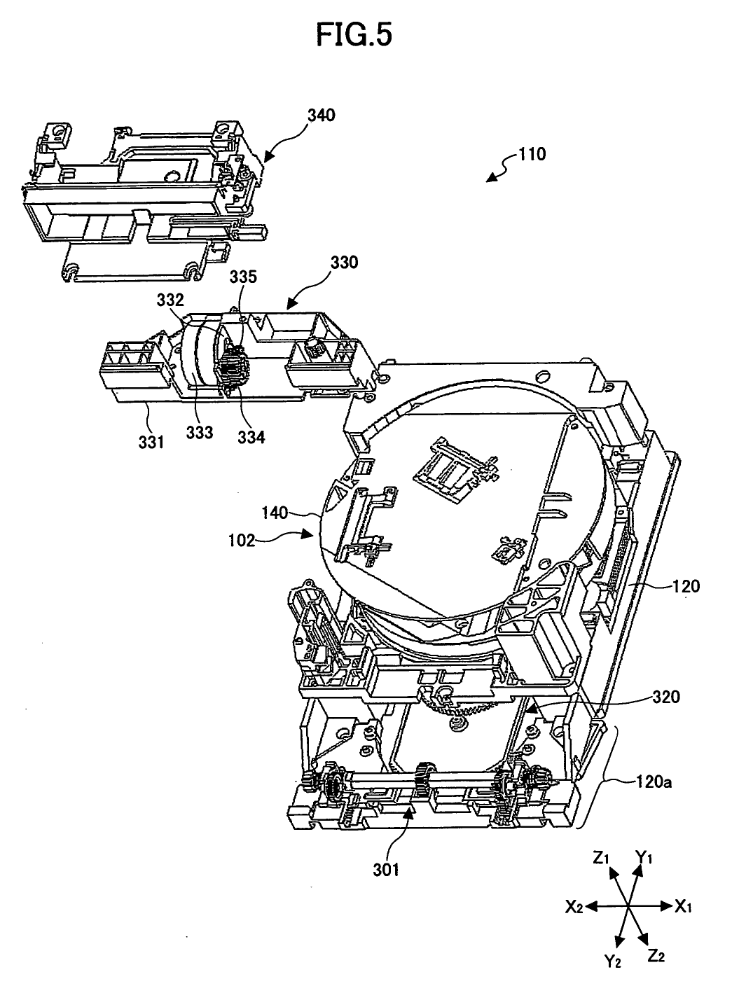

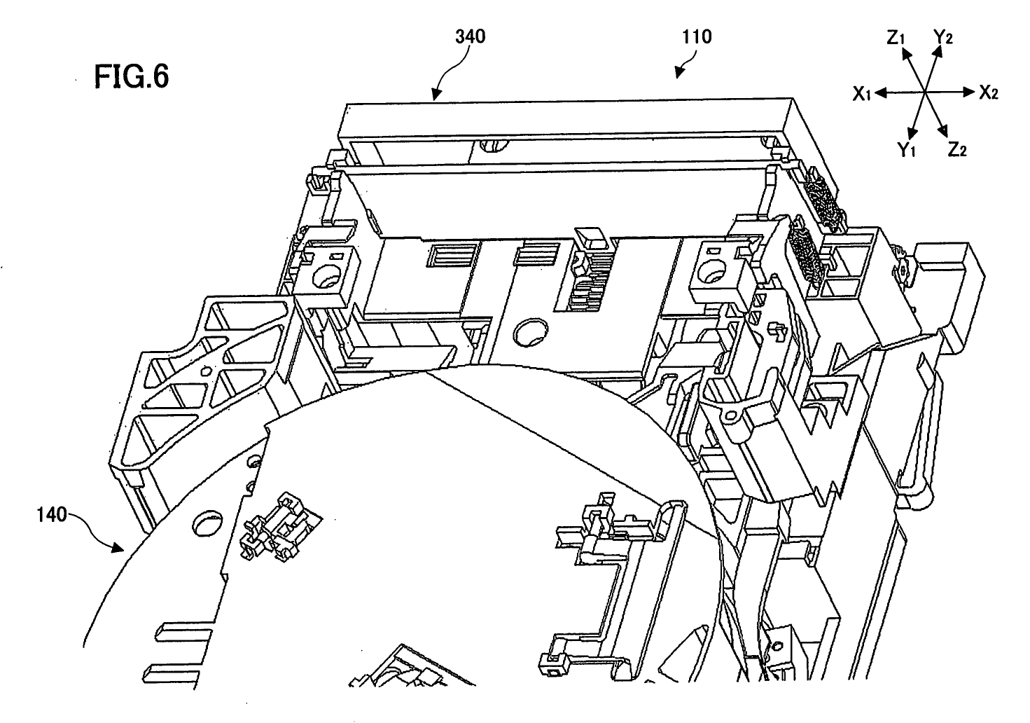

FIG. 4 is a perspective view of the main module 110. FIG. 5 is an exploded view of the main module 110. FIG. 6 is a perspective view of the main module 110, viewed from the Y1 side.

In this embodiment, the main module 110 includes a base 120. The main module 110 also includes the tape cartridge picker 102 and a tape cartridge transport magazine drive 300. The tape cartridge picker 102 can occupy a large part of the base 120. The base 120 includes an extension 120a extending at the Y2 side of the tape cartridge picker 102. A drive shaft unit 301 and a tape cartridge transport magazine drive motor module 330 are disposed on the extension 120a. In one embodiment, a mail slot module 340 can be mounted on the upper side of the magazine drive motor module 330. The magazine drive 300 comprises the drive shaft unit 301 and the magazine drive motor module 330 as described below.

A motor control circuit 410 shown in FIG. 4 drives, in response to a command generated when a user operates the control panel 105, a stepping motor 165 and a magazine drive motor 333 in a manner described below while monitoring signals from a photo sensor 370.

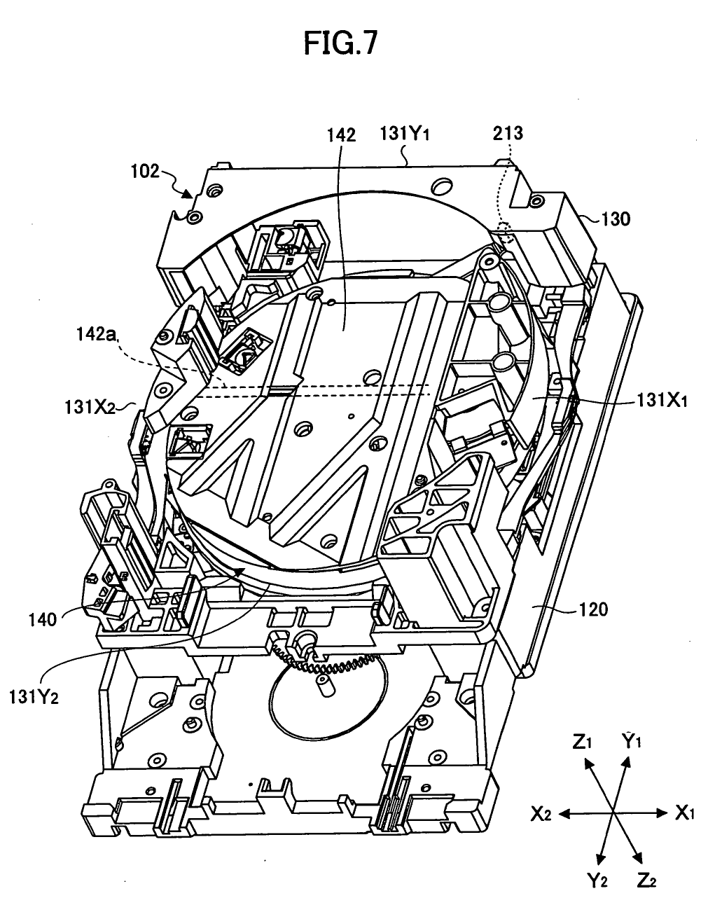

3 [Configuration and Operations of Tape Cartridge Picker 102] (FIGS. 7-12)

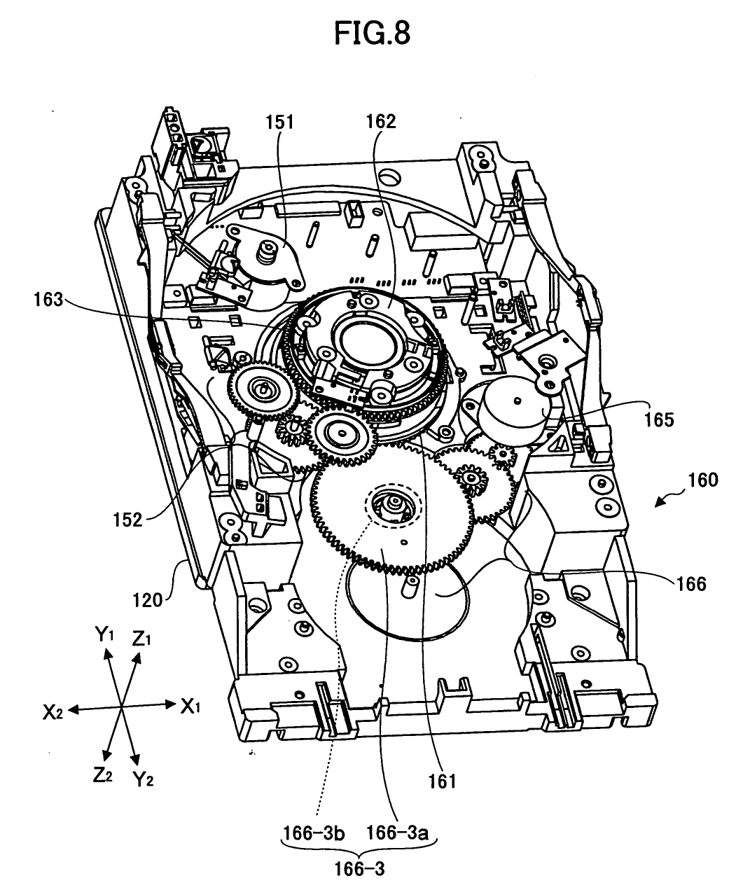

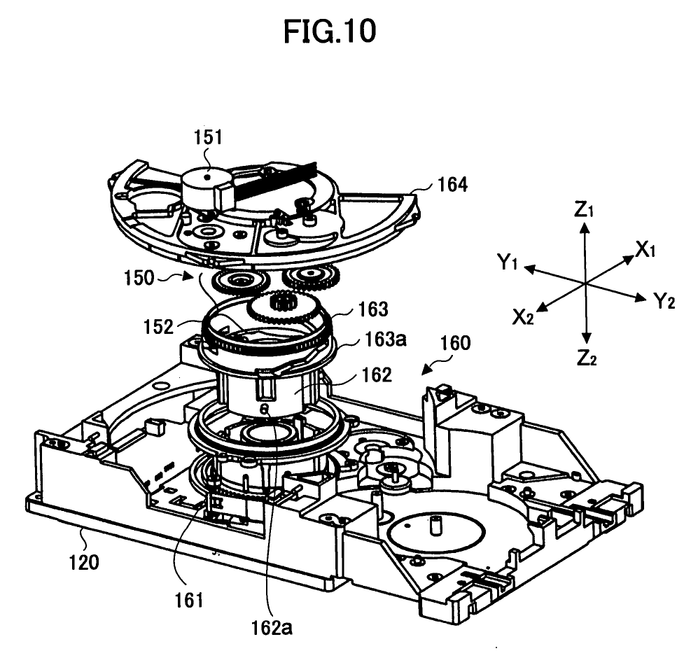

FIG. 7 illustrates the tape cartridge picker 102 with an upper plate 143 of the turntable 140 removed. FIG. 8 illustrates the tape cartridge picker 102 with a pillar 130 and the turntable 140 removed. FIG. 9 is an exploded perspective view illustrating the tape cartridge picker 102. FIG. 10 illustrates the turntable lifting mechanism 150 in detail.

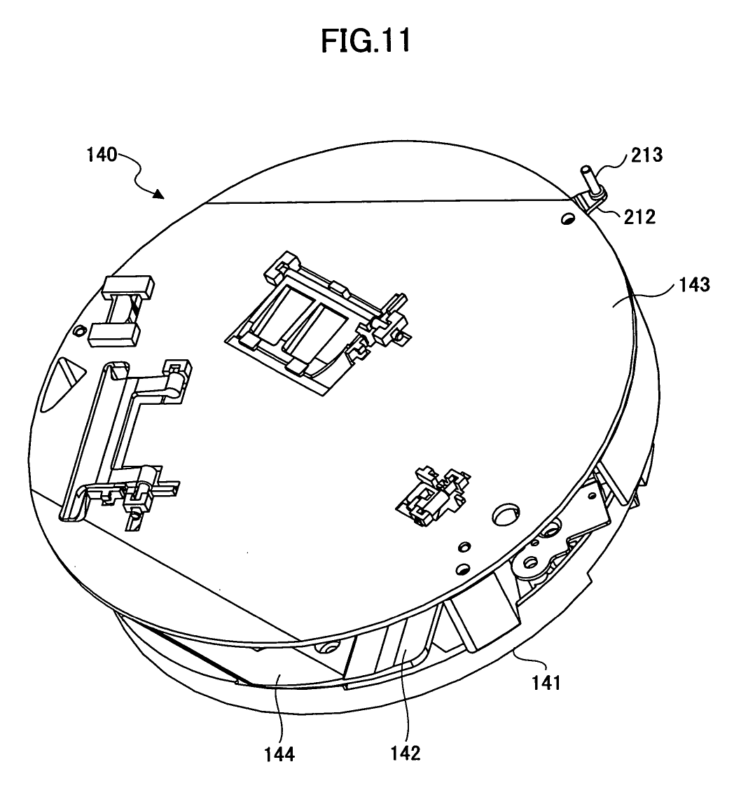

The tape cartridge picker 102 includes the pillar 130 mounted on the base 120, the turntable 140 (FIG. 11) configured to support the tape cartridge 10, the turntable lifting mechanism 150 (FIG. 10) configured to slightly raise and lower the turntable 140 for height position adjustment, and a turntable rotating mechanism 160 configured to rotate the turntable 140 by a predetermined rotational increment, such as by 90-degree increments, for example. The tape cartridge picker 102 has ports 131X1, 131X2, 131Y1, and 131Y2 on four sides thereof (see FIG. 7).

A rotating ring gear 161, a cylindrical stand 162, a lifting ring gear 163, and a sub base 164 are disposed on the base 120. The rotating ring gear 161 is rotatably coupuled to the base 120. The cylindrical stand 162 is arranged at the inner side of the rotating ring gear 161 and the lifting ring gear 163 so as to be rotated along with the rotating ring gear 161 and be raised independently from the rotating ring gear 161. The lifting ring gear 163 is arranged at the upper side of the rotating ring gear 161 so as to be rotated independently from the rotating ring gear 161. A boss 162a (FIG. 10) of the cylindrical stand 162 is configured to engage a diagonal groove 163a of the lifting ring gear 163. The cylindrical stand 162 is rotated by rotation of the rotating ring gear 161, and raised/lowered by rotation of the lifting ring gear 163. The sub base 164 is a semi-circular plate fixed to a position slightly separated from and at the upper side of the base 120.

Referring to FIG. 11, the turntable 140 includes a base plate 141, a floor plate 142, the upper plate 143, and a clearance 144 between the floor plate 142 and the upper plate 143 to receive the tape cartridge 10. The base plate 141 is screwed onto the cylindrical stand 162 (FIG. 10).

Referring to FIG. 10, the turntable lifting mechanism 150 includes a stepping motor 151, a gear train 152, and the lifting ring gear 163. Both the stepping motor 151 and the gear train 152 are provided on the base plate 141.

As shown in FIG. 8, the turntable rotating mechanism 160 includes a stepping motor 165, a reduction gear train 166, and the rotating ring gear 161, all of which are provided on the sub base 164 (FIG. 9). A two-stage gear 166-3, which is the last stage gear of the reduction gear train 166, comprises a large-diameter gear section 166-3a and a small-diameter gear section 166-3b.

The turntable lifting mechanism 150 has a function of initializing the turntable 140 by raising/lowering the turntable 140 to a home position thereof in the Z direction. The turntable rotating mechanism 160 has a function of initializing the turntable 140 by rotating the turntable 140 to the home position in the rotation direction. The home position of the turntable 140 is a position where a y-axis (described later) becomes parallel to the Y-axis. The lifting mechanism initialization operation and the turntable rotating mechanism initialization operation apply a method of moving an object to an operation end position defined as a reference position, and then moving the object back by a predetermined distance. The same method is applied to operations for initializing a tape cartridge transport mechanism 170 (described below).

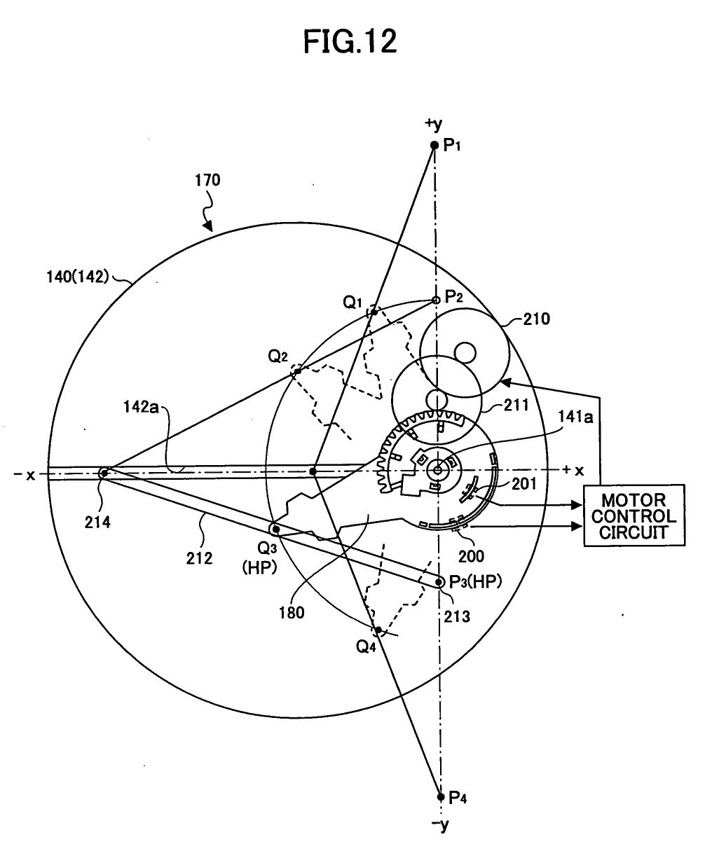

Referring to FIG. 11, the turntable 140 includes the base plate 141, the floor plate 142, the upper plate 143, and the clearance 144 between the floor plate 142 and the upper plate 143 to receive the tape cartridge 10. Referring to FIG. 12, the turntable 140 has coordinates applied wherein the position of a pin 141a (to be described below) is defined as the origin, a guide groove 142a (to be described below) is defined as an x-axis, and an axis passing through the origin and being orthogonal to the x-axis is defined as a y-axis.

The tape cartridge transport mechanism 170 and a stepping motor 210 (described later), both shown in FIG. 12, are provided on the base plate 141 (FIG. 11).

The tape cartridge transport mechanism 170 has a function of moving the tape cartridge 10 between a position on the turntable 140, i.e., a position inside the clearance 144, and a position outside the tape cartridge picker 102. In one embodiment, this movement can be substantially linear. Alternatively, the movement can be non-linear, or can include both linear and non-linear movements. The tape cartridge transport mechanism 170 includes a rotary arm 180 rotatably attached to the pin 141a formed on the base plate 141, the stepping motor 210 (FIG. 12) configured to reciprocally rotate the rotary arm 180 between positions Q1 and Q4 within a predetermined angular range, a reduction gear mechanism 211 configured to transmit the rotation of the motor 210 at a reduced rotation rate to the rotary arm 180, and a lever 212 with a center part rotatably connected to a tip end of the rotary arm 180. A cartridge pin 213 is vertically fixed to an end of the lever 212, while a pin 214 is fixed to the other end of the lever 212. The pin 214 engages the guide groove 142a formed on a lower face of the floor plate 142.

In one embodiment, the turntable rotating mechanism 160 can rotate the turntable 140 in approximately 90-degree increments, for example, in the clockwise direction or the counterclockwise direction with respect to the home position such that the orientation of the tape cartridge 10 is changed. In non-exclusive alternative embodiments, the turntable 140 can be rotated greater than or less than approximately 90 degrees in either direction. The tape cartridge transport mechanism 170 retrieves the tape cartridge 10 and transports it onto and off of the turntable 140 (see FIG. 3) while the cartridge pin 213 is engaged in the notch 15a of the tape cartridge 10 (FIG. 1).

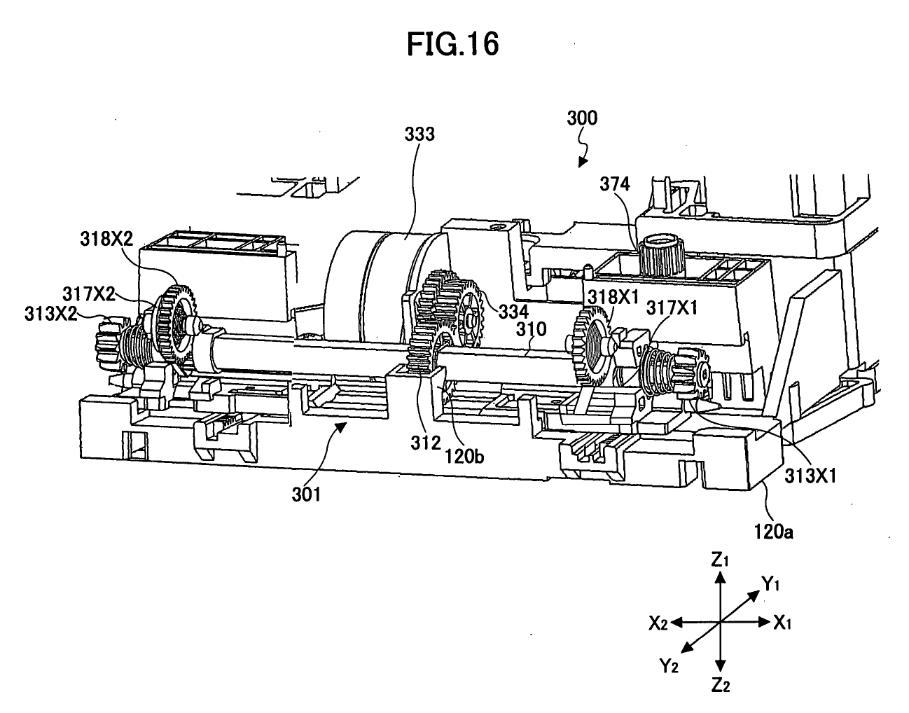

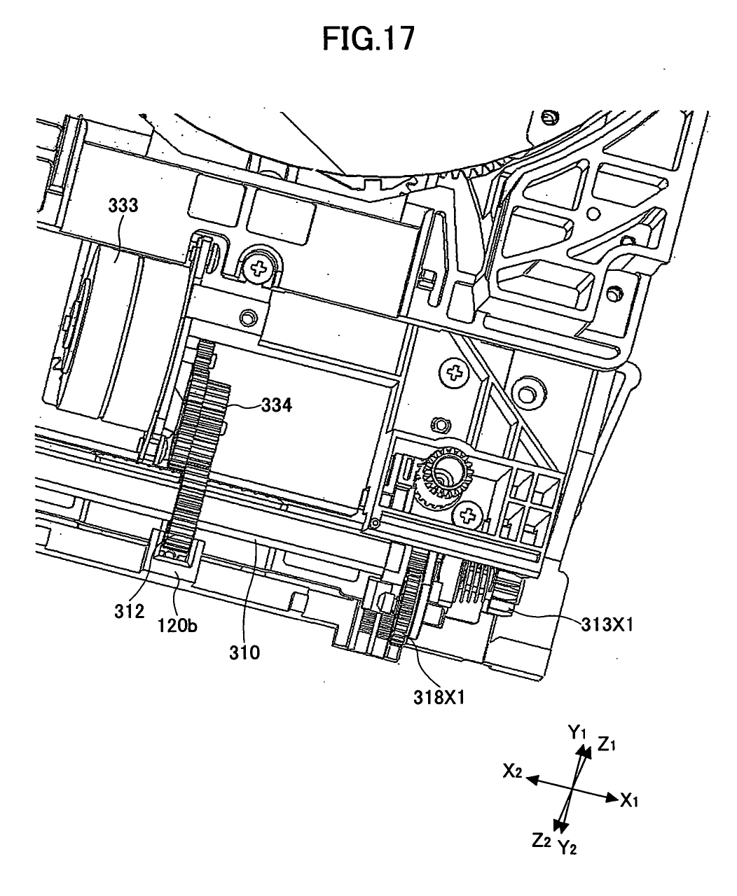

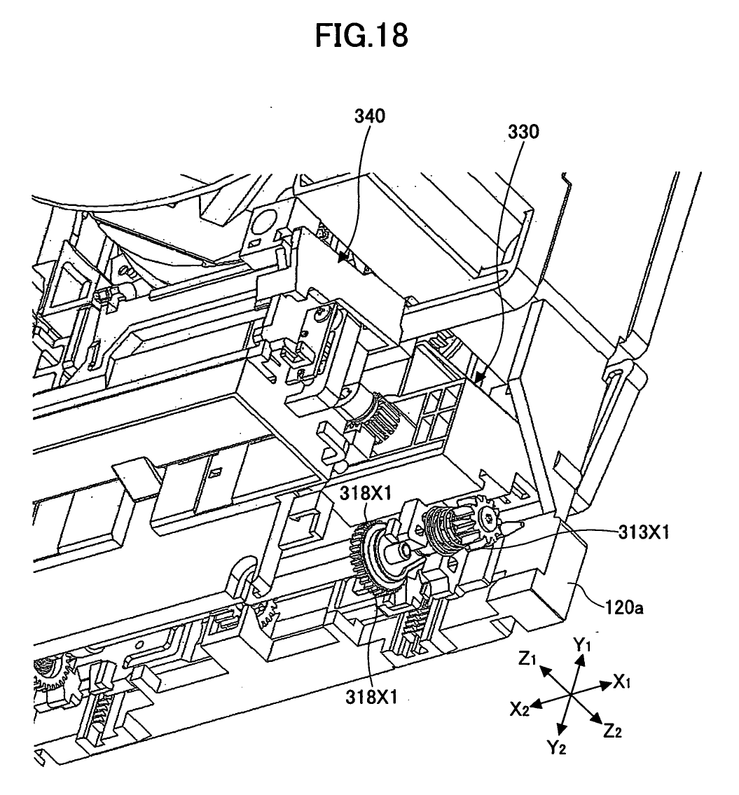

4 [Configuration of Tape Cartridge Transport Magazine Drive 300] (FIGS. 4-6, FIGS. 13-20)

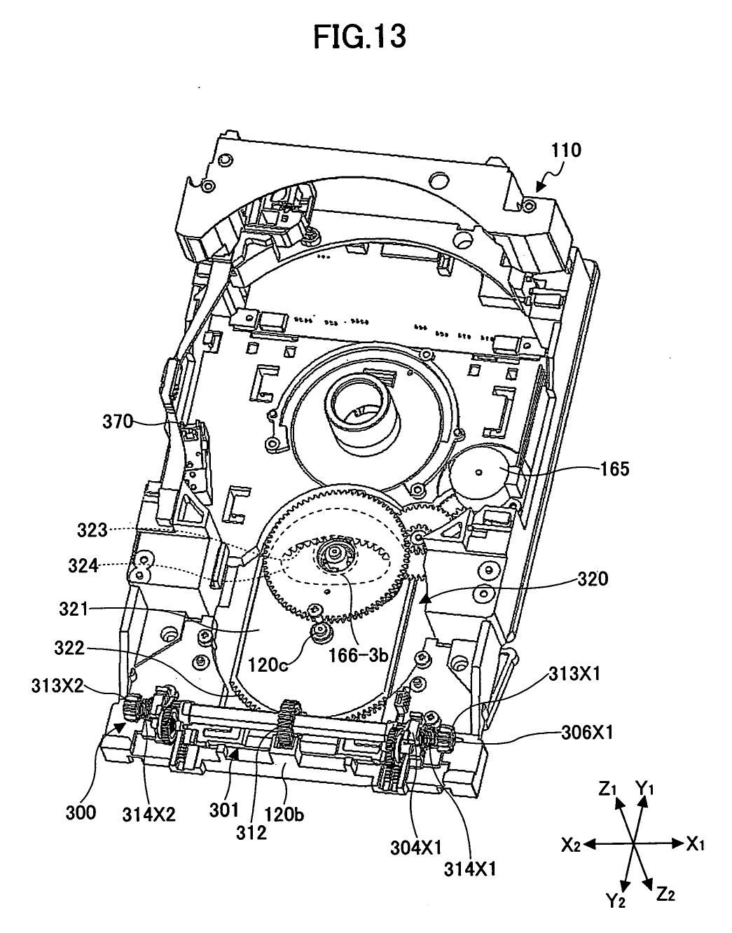

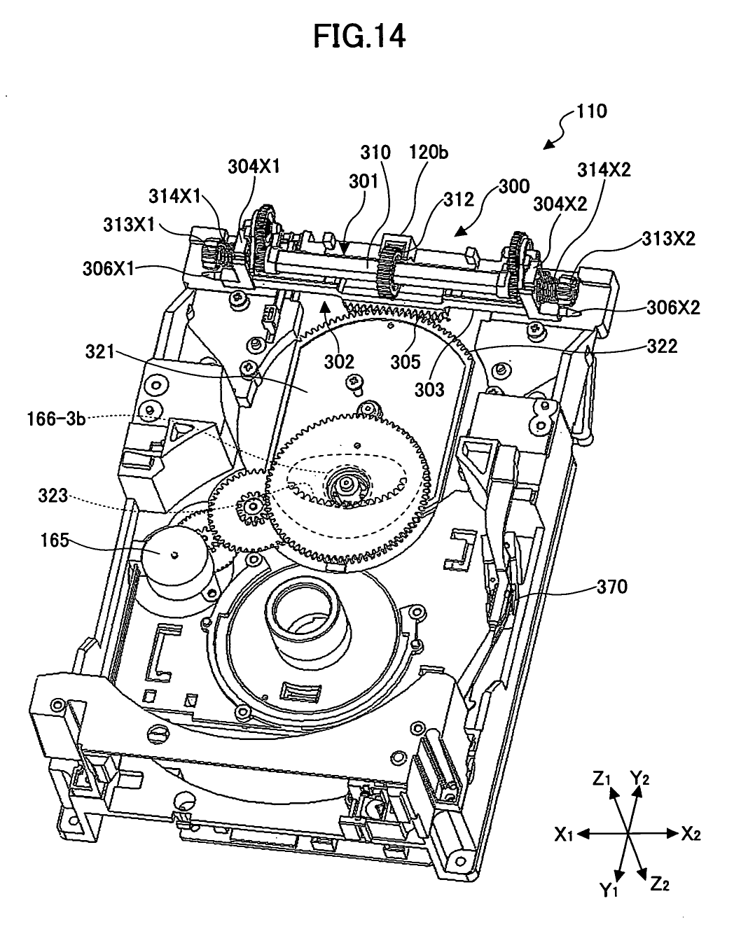

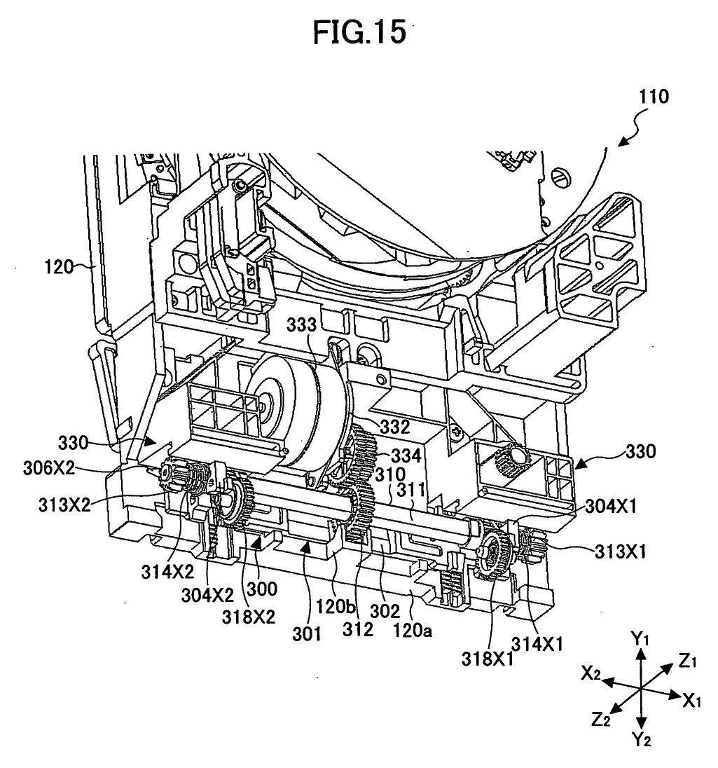

FIG. 13 is a perspective view of the main module 110 with the tape cartridge picker 102, the mail slot module 340, and the motor module 330 removed, viewed from the Y2 side. FIG. 14 is a perspective view of the main module 110 of FIG. 13, viewed from the Y1 side. FIG. 15 is a perspective view of a Y2-side part of the main module 110 with the mail slot module 340 removed.

With reference to FIGS. 4, 5, and 13-15, the tape cartridge transport magazine drive 300 comprises the drive shaft unit 301, the drive shaft unit shift mechanism 320, and the magazine drive motor module 330.

4-1 [Configuration of Drive Shaft Unit 301]

Referring to FIGS. 5, 6, and 13-18, the drive shaft unit 301 comprises a frame 302, a drive shaft 310, a center gear 312, drive gears 313X1 and 313X2 disposed one on each end of the drive shaft 310, and is installed on the base 120 movably in the X1-X2 direction. FIGS. 5, 6, and 13-18 show the drive shaft unit 301 located at its home position.

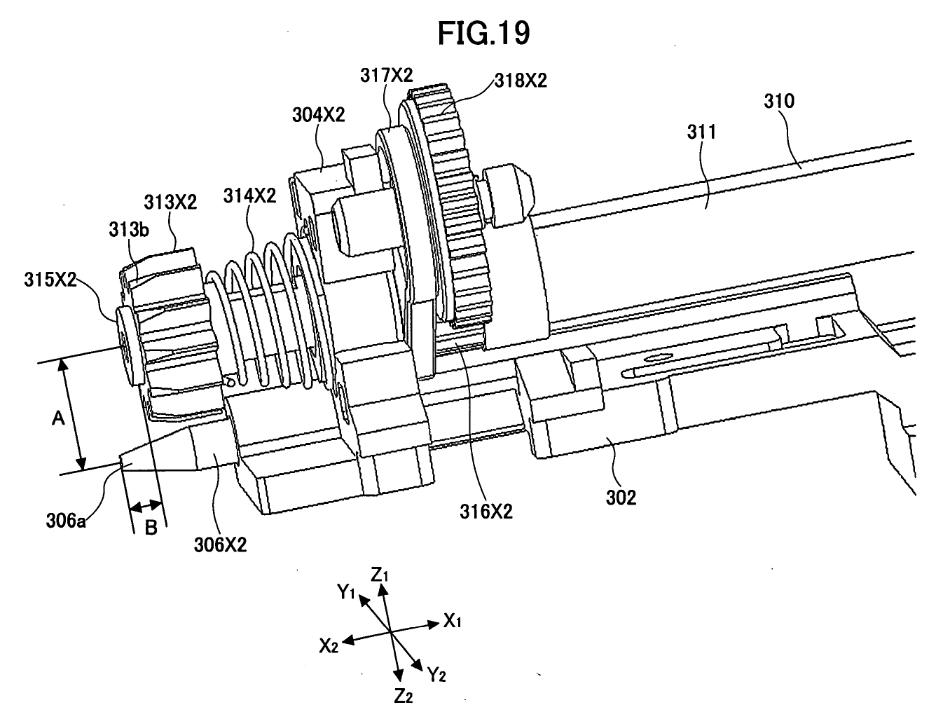

The frame 302 (FIG. 15) comprises a frame main body 303 (FIG. 14) elongated in the X1-X2 direction, flanges 304X1 and 304X2 formed one at each end of the frame main body 303, a rack 305 (FIG. 14) at the center of the frame main body 303, and positioning pins 306X1 and 306X2 provided one on each end of the frame main body 303. Each of the positioning pins 306X1 and 306X2 includes a conical section 306a (FIG. 19). The frame 302 is disposed on the extension 120a of the base 120 movably in the X1-X2 direction.

The drive shaft 310 is rotatably supported at both ends by the flanges 304X1 and 304X2. Gears 316X1 and 316X2 (FIG. 19) are secured to the drive shaft 310 at the inner side of the flanges 304X1 and 304X2. The gears 316X1 and 316X2 inhibit the drive shaft 310 from moving with respect to the flanges 304X1 and 304X2 in the X1-X2 direction. In one embodiment, the drive shaft 310 has a flat face 311 in its diametrical direction at least at the center and ends thereof so as to have a substantially D-shaped cross section, on which the center gear 312 fits. The drive shaft 310 is configured to rotate with the center gear 312 and is movable in the X1-X2 direction with respect to the center gear 312. In this embodiment, as the center gear 312 is fitted in a holder section 120b formed integrally on the base 120, the movement of the center gear 312 in the X1-X2 direction is restricted.

The drive gears 313X1 and 313X2 are attached to the drive shaft 310 at the outer side of the flanges 304X1 and 304X2, respectively. The drive gears 313X1 and 313X2 are configured to rotate with the drive shaft 310, and are slidable-along the drive shaft 310 in the axial direction of the drive shaft 310. Washers 315X2 (FIG. 19) can be threaded on the end faces of the drive shaft 310 to inhibit the drive gears 313X1 and 313X2 from dropping off. Compression coil springs 314X1 and 314X2 are wound around the drive shaft 310 between the drive gears 313X1, 313X2 and the flanges 304X1, 304X2, respectively. The drive gear 313X2 compresses the compression coil spring 314X2 to move in the X1 direction when a force in the X1 direction is applied to the drive gear 313X2. The drive gear 313X1 compresses the compression coil spring 314X1 to move in the X2 direction when a force in the X2 direction is applied to the drive gear 313X1.

As shown in detail in FIG. 19, there is a distance A between the positioning pin 306X2 and the drive shaft 310. The positioning pin 306X2 extends further outward than the drive gear 313X2 by a distance B. The drive gear 313X2 is a spur gear having a tapered face 313b on the outer end. The drive gears 313X1 and the positioning pin 306X1 also have the configurations as described above.

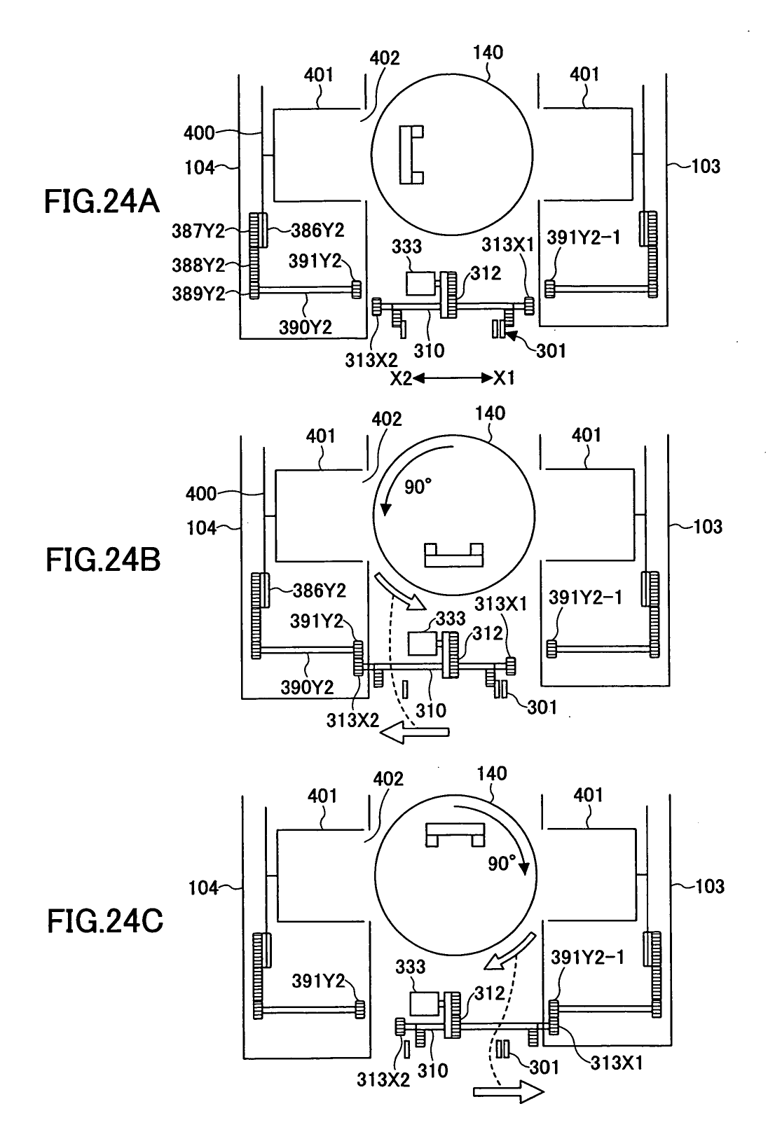

The drive shaft unit 301 is usually located at a home (center) position shown in FIGS. 4 and 24A. When the drive shaft unit 301 is at the home position, the drive gears 313X1 and 313X2, the positioning pins 306X1 and 306X2 are located within the width of the base 120 in the X1-X2 direction.

Swing arms 317X1 and 317X2 are attached to the drive shaft 310 between the gears 316X1, 316X2 and the flanges 304X1, 304X2, respectively. Gears 318X1 and 318X2 are attached to ends of the swing arms 317X1 and 317X2. The gears 318X1 and 318X2 engage, e.g., mesh with, the gears 316X1 and 316X2, respectively. The swing arms 317X1 and 317X2 swing in the same direction as the drive shaft 310 rotates.

4-2 [Configuration of Drive Shaft Unit Shift Mechanism 320]

The drive shaft unit shift mechanism 320 utilizes the stepping motor 165 that rotates the turntable 140. The drive shaft unit shift mechanism 320 comprises the stepping motor 165 and a gear member 321 (see FIGS. 13 and 14).

The gear member 321 has a generally elliptical shape, comprising an outer gear section 322 and an inner gear section 323 along the edge of an inner opening 324. A center hole of the gear member 321 fits on a shaft portion 120c of the base 120. The inner gear section 323 engages a small-diameter gear section 166-3b, while the outer gear section 322 engages the rack 305 (FIG. 14).

When the stepping motor 165 is driven, the turntable 140 is rotated through the gear train 166. At the same time, the gear member 321 is rotated thought the small-diameter section 166-3b in the clockwise direction or the counterclockwise direction in accordance with the rotational direction of the stepping motor 165, so that the drive shaft unit 301 is moved through the rack 305 in the X2 direction or the X1 direction.

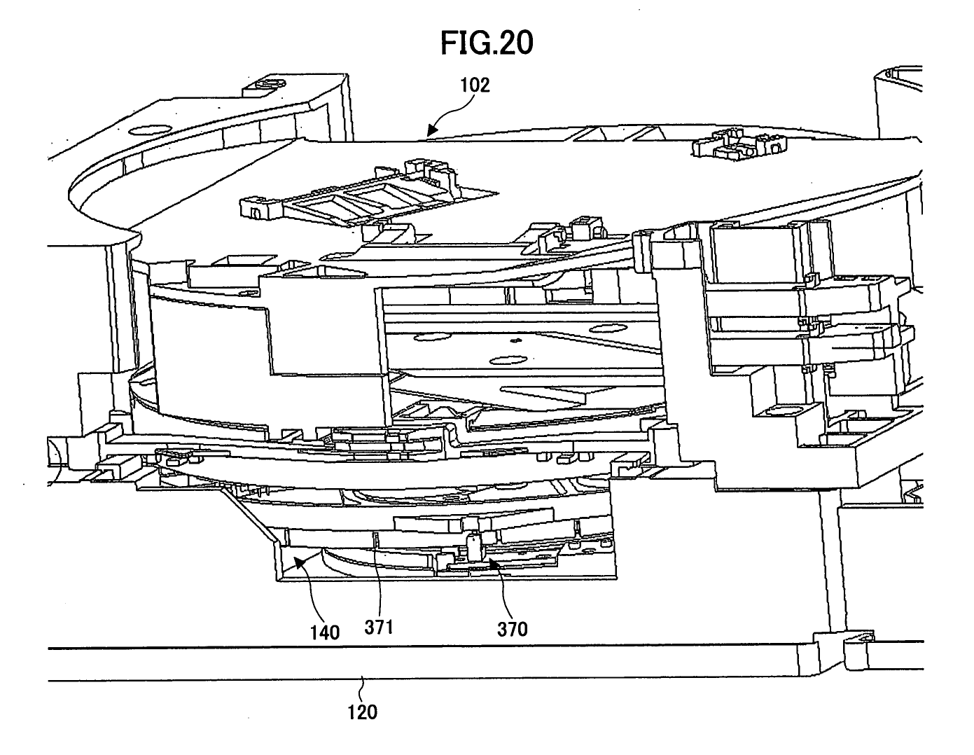

Referring to FIG. 20, the photo sensor 370 for detecting the rotating angle of the turntable 140 is provided. The photo sensor 370 detects the rotating angle of the turntable 140 by detecting slits 371, which can be formed in a predetermined arrangement on a rib around a lower face of the turntable 140. In one embodiment, for example, the rotating angle of the turntable 140 and the moving distance of the drive shaft unit 301 have the following relation: When the rotating angle of the turntable 140 is approximately 15 degrees, the moving distance of the drive shaft unit 301 is approximately 2.5 mm; when the rotating angle of the turntable 140 is approximately 30 degrees, the moving distance of the drive shaft unit 301 is approximately 5 mm; and when the rotating angle of the turntable 140 is approximately 90 degrees, the moving distance of the drive shaft unit 301 is approximately 15 mm. However, it is recognized that other equally suitable arrangements can be utilized with the present invention depending upon the design requirements of the autoloader 100.

4-3 [Configuration of Magazine Drive Motor Module 330]

As shown in FIG. 5, in the magazine drive motor module 330, the magazine drive motor 333 is secured to a flange section 332 of a frame 331. A reduction gear 334 is held in the flange section 332. The reduction gear 334 engages a gear 335 secured to a spindle of the magazine drive motor 333.

The magazine drive motor module 330 is secured to the Y1-side end of the base 120 such that the reduction gear 334 engages the gear 312 as shown in FIG. 15.

When the magazine drive motor 333 is driven, the gear 312 is rotated through the reduction gear 334. Accordingly, the drive shaft 310 and the drive gears 313X1 and 313X2 are rotated.

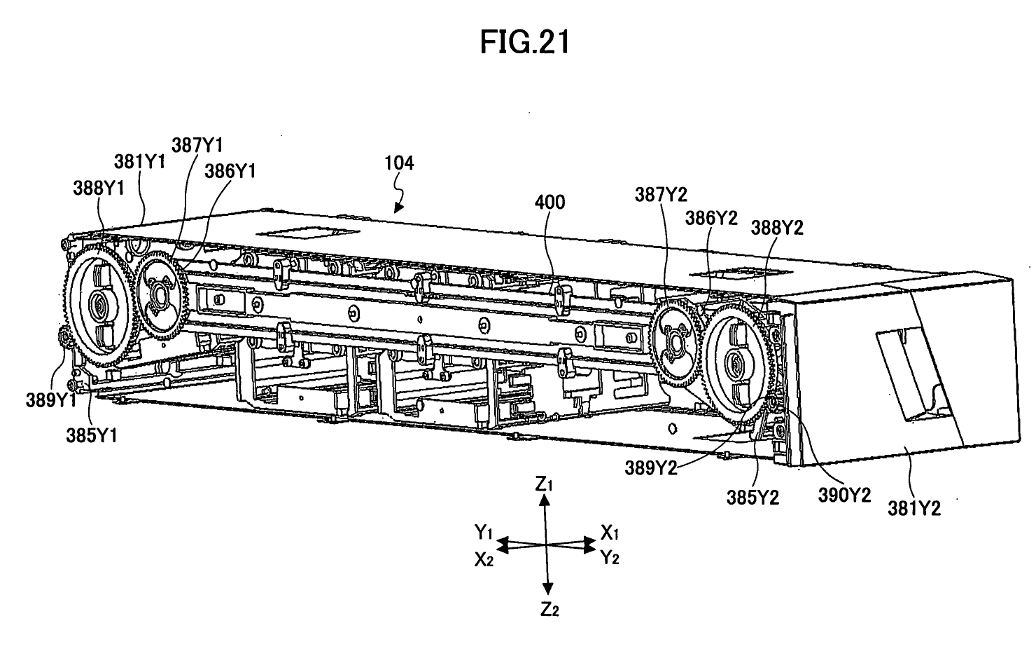

5 [Configuration of Tape Cartridge Transport Magazines 103, 104] (FIGS. 21-23)

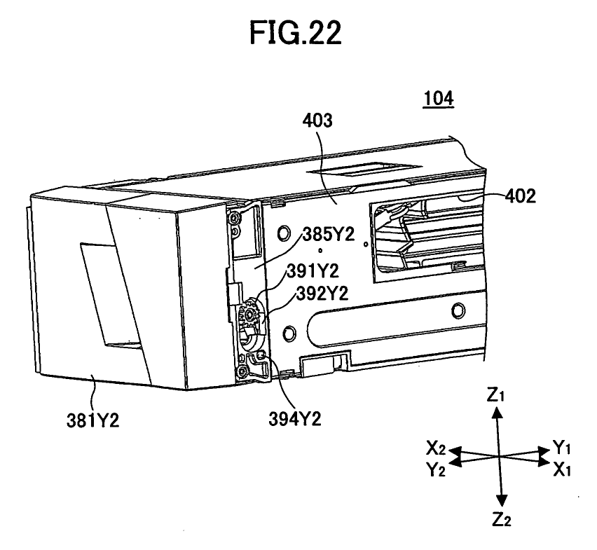

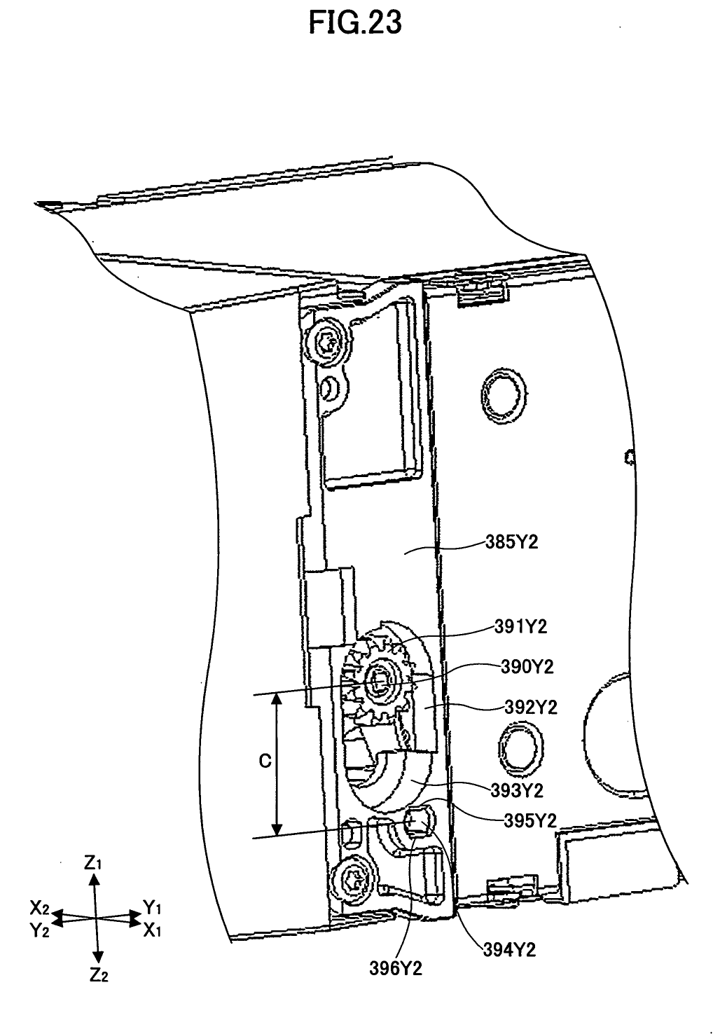

FIG. 21 is a perspective view of the tape cartridge transport magazine 104 with an X2-side lateral plate removed, viewed from the X2 side. FIG. 22 is a perspective view of the tape cartridge transport magazine 104 of FIG. 21, viewed from the X1 side. FIG. 23 is an enlarged view illustrating a part of the tape cartridge transport magazine 104 of FIG. 22.

Referring to FIG. 21, the tape cartridge transport magazine 104 is a somewhat quadrangular prism elongated in the Y1-Y2 direction and comprises decorative panels 381Y1 and 381Y2 at opposing ends in the longitudinal direction. In one embodiment, the tape cartridge transport magazine 104 is installable at both the X1 side and the X2 side of the main module 110 by reversing the longitudinal orientation without turning it upside down.

As shown in FIG. 21, a frame 385Y2, a pulley 386Y2, a large-diameter gear member 388Y2 that engages a gear section 387Y2 provided at the end of the pulley 386Y2, and a small-diameter gear member 389Y2 that engages the large-diameter gear member 388Y2 are provided at the Y2 side. The small-diameter gear member 389Y2 is secured to an end of a rotary shaft 390Y2.

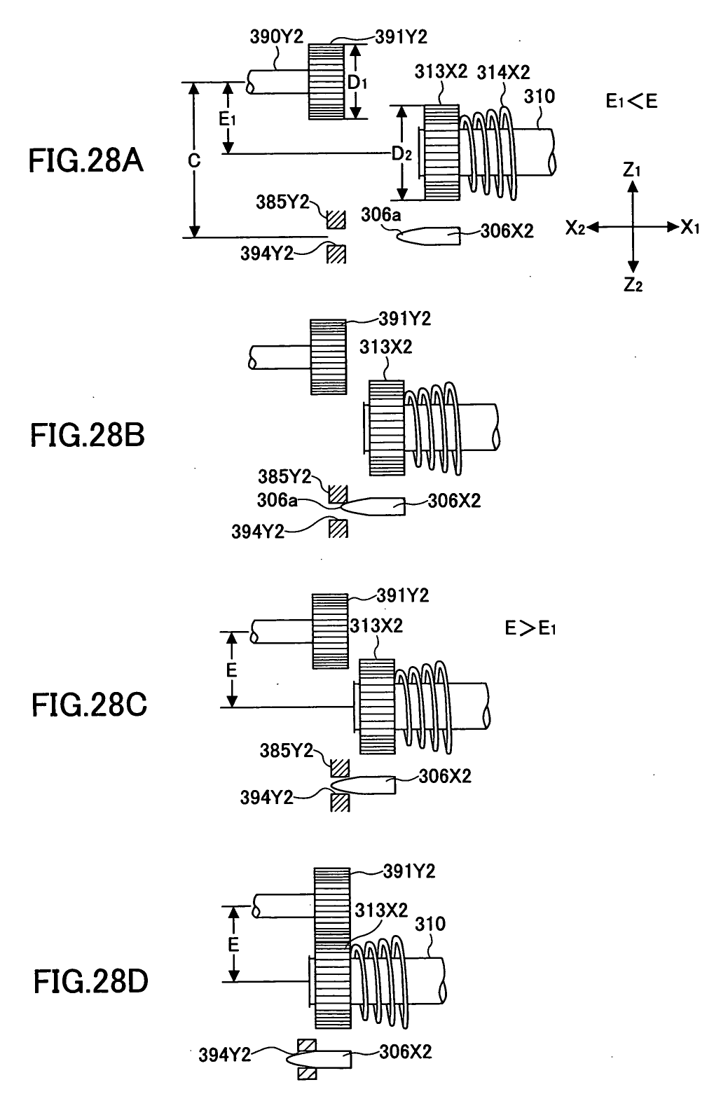

As shown in FIGS. 22 and 23, a small-diameter magazine gear 391Y2 is secured to the opposite end of the rotary shaft 390Y2. An opening 392Y2 elongated in the Z direction is formed in the frame 385Y2. The magazine gear 391Y2 is exposed from a Z1-side part of the opening 392Y2. The opening 392Y2 includes an opening portion 393Y2 having a size that allows the drive gear 313X2 to be fitted therein. A positioning hole 394Y2 is formed at the Z2 side of the opening portion 393Y2 in the frame 385Y2. The positioning hole 394Y2 is elongated in the Y1-Y2 direction and can include linear edges 395Y2 and 396Y2 at the Z1 side and the Z2 side, each extending in the Y1-Y2 direction. The positioning hole 394Y2 is formed at the Z2 side of the magazine gear 391Y2 with a distance C therebetween (see FIG. 28A). The distance C is determined based on the distance A (FIG. 19), a pitch circle diameter D1 of the magazine gear 391Y2, and a pitch circle diameter D2 of the drive gear 313X2 such that the center distance between the magazine gear 391Y2 and the drive gear 313X2 is set to an appropriate value E when the positioning pin 306X2 is fitted in the positioning hole 394Y2 (see FIGS. 28A and 28D).

Referring back to FIG. 21, a frame 385Y1, a pulley 386Y1, a gear section 387Y1, a large-diameter gear member 388Y1, a small-diameter gear member 389Y1, and a magazine gear are provided at the Y1 side substantially similar to the Y2 side.

Plural tape cartridge containers 401 can be disposed at even intervals on a belt 400 extending around the pulleys 386Y1 and 386Y2 (see FIGS. 2 and 21). Alternatively, the tape cartridge containers 401 can be arranged in a different manner, e.g., uneven, on the belt 400 than that shown in FIG. 2.

An opening 402 (FIG. 22) having a size corresponding to the tape cartridge 10 is formed in an X1-side lateral plate 403 of the tape cartridge transport magazine 104 so as to oppose the tape cartridge picker 102 when the tape cartridge transport magazine 104 is mounted. Also, openings (not shown) for inserting tape cartridges 10 can be formed in the lateral plate 403 of the tape cartridge transport magazine 104 so as to oppose the corresponding tape cartridge containers 401.

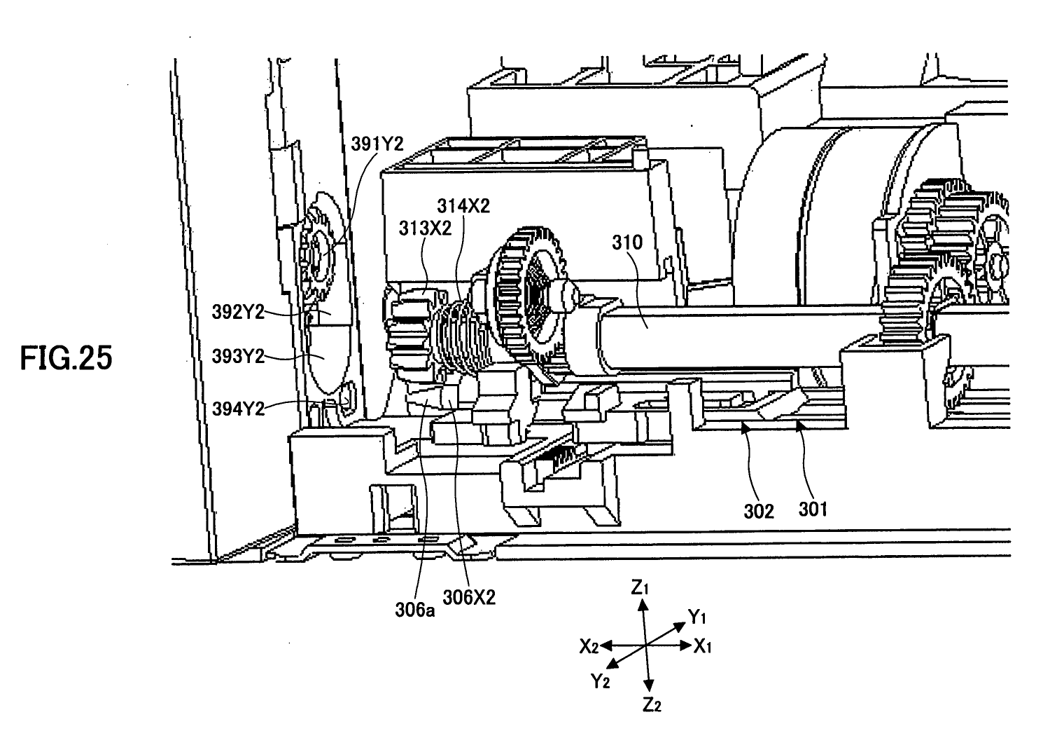

When the tape cartridge transport magazines 103 and 104 are attached at the X1 side and the X2 side as shown in FIG. 1, the drive shaft unit 301 can be located at the home position shown in FIG. 24A. At the X2 side, as shown in FIG. 25, the magazine gear 391Y2, the opening 392Y2, and the positioning hole 394Y2 oppose the drive gear 313X2 (313X1) and the positioning pin 306X2 (306X1). The opening 402 opposes the tape cartridge picker 102.

6 [Operations for Selectively Driving Tape Cartridge Transport Magazines 103, 104] (FIGS. 24A-29D)

FIG. 24B shows a state to drive the tape cartridge transport magazine 104. FIG. 24C shows a state to drive the tape cartridge transport magazine 103.

When a command to drive the tape cartridge transport magazine 104 is input, the stepping motor 165 is driven in the normal direction by the motor control circuit 410 so as to drive the magazine drive motor 333 (see FIG. 4).

When the stepping motor 165 is driven, the turntable 140 is rotated in the counterclockwise direction through the reduction gear train 166. At the same time, the drive shaft unit 301 is driven in the X2 direction through the gear member 321 and the rack 305. In one embodiment, the stepping motor 165 is stopped at the time when the photo sensor 370 detects that the turntable 140 is rotated approximately 90 degrees in the counterclockwise direction. The drive shaft unit 301 is moved in the X2 direction, so the drive gear 313X2 is inserted into the opening portion 393Y2 to engage the magazine gear 391Y2. Thus, the magazine drive 300 establishes a rotation transmission path from the magazine drive motor 333 to the tape cartridge transport magazine 104.

The stepping motor 165 for rotating the turntable 140 can also be used for moving the drive shaft unit 301. Therefore, in this embodiment, there is no need to provide a stepping motor exclusively used for moving the drive shaft unit 301. It is so designed that the tape cartridge picker 102 is at rest while the tape cartridge transport magazine 104 is driven. According to the present embodiment, a part of the tape cartridge picker 102 is operated for moving the drive shaft unit 301.

As the drive shaft unit 301 is interlocked with the turntable 140, the moving distance of the drive shaft unit 301 is found by detecting the rotating angle of the turntable 140. Therefore, there is no need to provide the drive shaft unit 301 with a mechanism for detecting the moving distance.

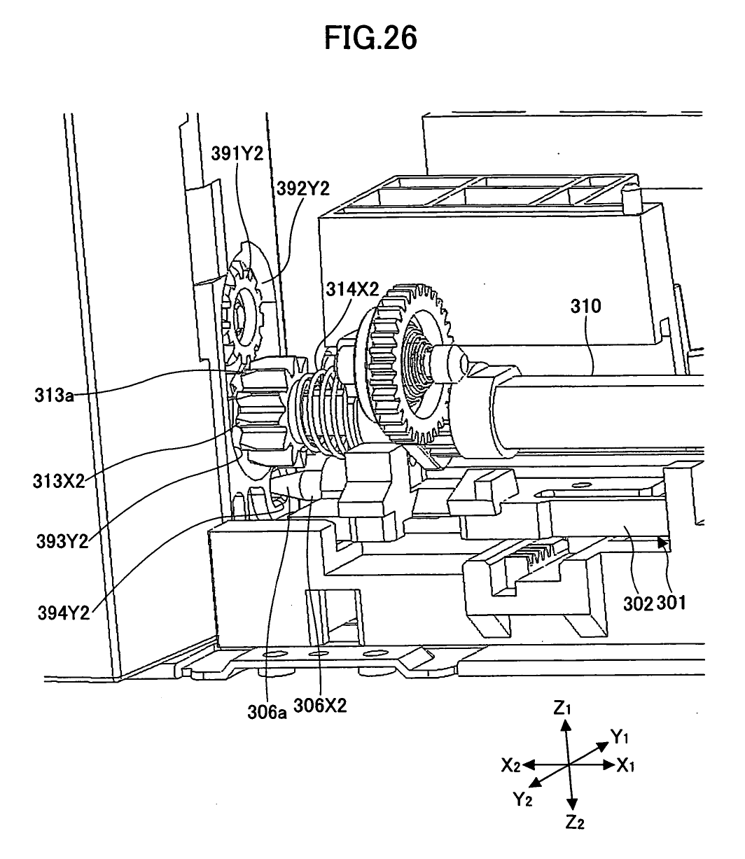

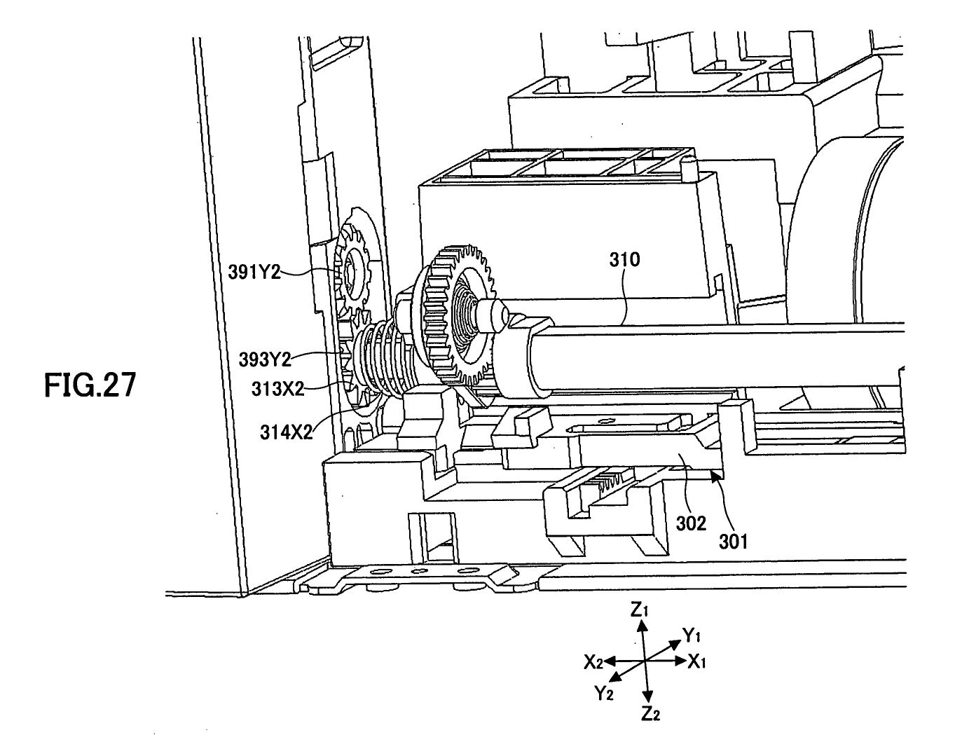

At the final stage of the movement of the drive shaft unit 301 in the X2 direction, the following operations illustrated in FIGS. 26 and 27 are performed.

Just before the drive gear 313X2 contacts the magazine gear 391Y2, the positioning pin 306X2 fits into the positioning hole 394Y2 (see FIGS. 26, 28B, and 28C) so as to set the center distance between the magazine gear 391Y2 and the drive gear 313X2 to the appropriate value E. When the drive shaft unit 301 is further moved in the X2 direction to be inserted into the opening portion 393Y2 from the lateral side thereof, tooth sections of the drive gear 313X2 fit into tooth groove sections of the magazine gear 391Y2 (see FIGS. 27, 24B, and 28B). Thus, the drive gear 313X2 correctly engages the magazine gear 391Y2. The tapered face 313b helps the drive gear 313X2 to smoothly engage the magazine gear 391Y2.

FIGS. 28A-28D illustrate operations for correcting the center distance between the drive gear 313X2 and the magazine gear 391Y2 to the appropriate value E when the drive gear 313X2 engages the magazine gear 391Y2.

FIG. 28A illustrates the magazine gear 391Y2 and the drive gear 313X2 located at the positions shown in FIGS. 24A and 25. Supposing that the center distance between the magazine gear 391Y2 and the drive gear 313X2 is a value E1 smaller than the appropriate value E. This situation may occur when, for example, the frame 500 is distorted at the time of mounting the tape cartridge autoloader 100 on the rack or when there is an incorrect assembly in the tape cartridge autoloader 100.

When the drive shaft unit 301 is moved in the X2 direction, a tip end of the conical section 306a of the positioning pin 306X2 is inserted into the positioning hole 394Y2 as shown in FIG. 28B and further inserted as shown in FIG. 28C before the drive gear 313X2 reaches the magazine gear 391Y2. During this process, the drive gear 313X2 is slightly moved in the Z2 direction or the tape cartridge transport magazine 104 is slightly moved in the Z1 direction, so that the center distance between the magazine gear 391Y2 and the drive gear 313X2 is corrected to the appropriate value E. After the center distance is corrected to the appropriate value E, as shown in FIG. 28D, the drive gear 313X2 correctly engages the magazine gear 391Y2.

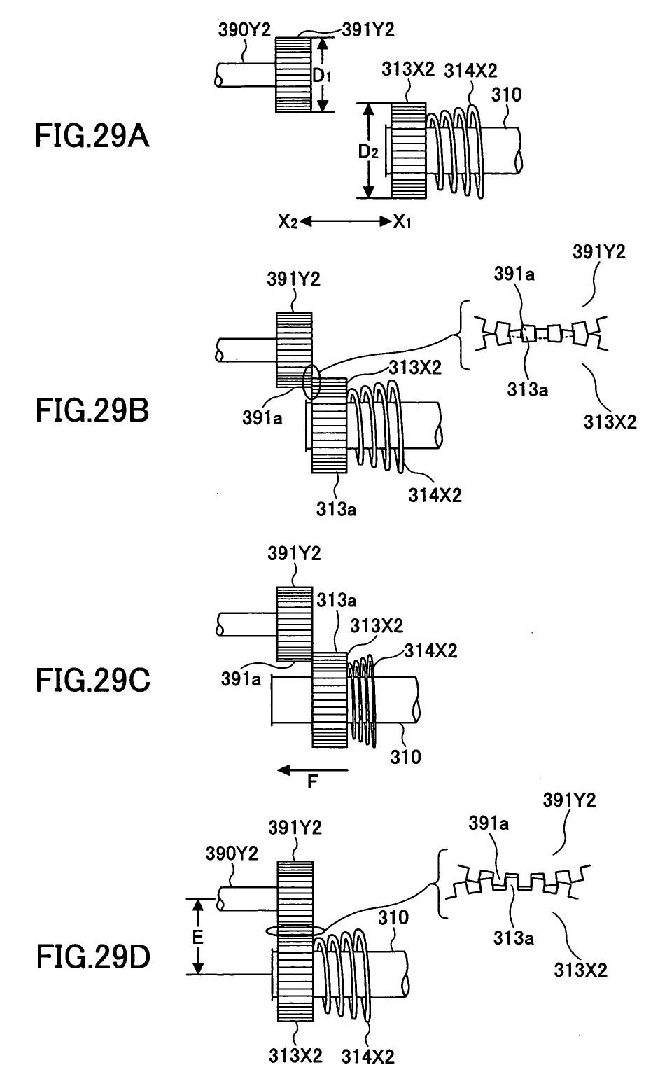

FIGS. 29A-29D illustrate operations for locating the drive gear 313X2 to correctly mesh with the magazine gear 391Y2 when the tooth sections of the drive gear 313X2 contact and interfere with tooth sections of the magazine gear 391Y2.

FIG. 29B illustrates the tooth sections of the drive gear 313X2, which are moved in the X2 direction from the original position shown in FIG. 29A, contacting and interfering with the tooth sections of the magazine gear 391Y2.

When the drive shaft unit 301 is further moved in the X2 direction, the compression coil spring 314X2 is compressed as shown in FIG. 29C. Thus, the drive shaft unit 301 is moved to the final position. The drive gear 313X2 is stopped with lateral end faces of the tooth sections 313a abutting opposing lateral end faces of the tooth section 391a of the magazine gear 391Y2.

Then, the magazine drive motor 333 is started as described below, and accordingly the drive gear 313X2 is rotated. When the tooth sections of the rotating drive gear 313X2 oppose the tooth groove sections of the magazine gear 391Y2, the drive gear 313X2 is moved in the X2 direction with a spring force F of the compression coil spring 314X2 so as to correctly mesh with the magazine gear 391Y2 as shown in FIG. 29D.

After the drive gear 313X2 engages the magazine gear 391Y2, the gear 312 is rotated by the magazine drive motor 333 through the reduction gear 334. Accordingly, the drive shaft 310, the drive gears 313X1 and 313X2 are rotated. The rotation of the drive gear 313X2 is transmitted to the magazine gear 391Y2, the large-diameter gear member 388Y2, the gear section 387Y2, and to the pulley 386Y2 (FIG. 24A). Thus, the belt 400 is driven so as to move the tape cartridge containers 401 together with the tape cartridges 10 stored in the tape cartridge containers 401.

When a command to stop driving the tape cartridge transport magazine 104 is input, the magazine drive motor 333 is stopped. Then, the stepping motor 165 is driven in the reverse direction to rotate the turntable 140 back to the home position. Also, the drive shaft unit 301 is moved through the gear member 321 and the rack 305 in the X1 direction back to the home position shown in FIG. 24A.

If a command to drive the tape cartridge transport magazine 103 is input when the drive shaft unit 301 is located at the home position shown in FIG. 24A, the stepping motor 165 is driven in the reverse direction by the motor control circuit 410 (FIG. 4) so as to drive the magazine drive motor 333. Thus, the drive gear 313X1 correctly engages a magazine gear 391Y2-1 of the tape cartridge transport magazine 103 (see FIG. 24C) in the same manner as described above. Accordingly, the belt 400 is driven by the magazine drive motor 333 so as to move the tape cartridge containers 401.

When a command to stop driving the tape cartridge transport magazine 103 is input, the magazine drive motor 333 is stopped. Then, the stepping motor 165 is driven in the reverse direction to rotate the turntable 140 back to the home position. Also, the drive shaft unit 301 is moved through the gear member 321 and the rack 305 in the X2 direction back to the home position shown in FIG. 24A.

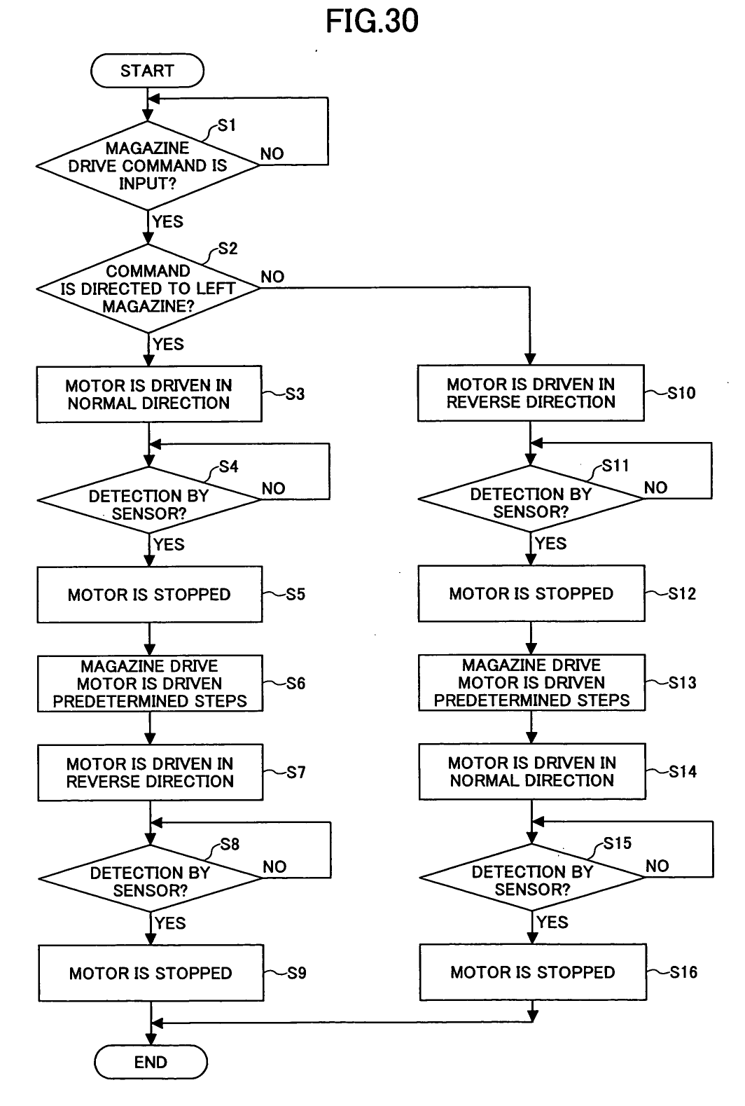

7 [Operations of Microcomputer of Motor Control Circuit 410] (see FIG. 30)

The microcomputer of the motor control circuit 410 operates as illustrated in FIG. 30.

When a magazine drive command is input, the microcomputer determines whether the command is directed to the first tape cartridge transport magazine 104 (S1, S2). If the command is directed to the first tape cartridge transport magazine 104, the microcomputer drives the stepping motor 165 in the normal direction. In one embodiment, when the photo sensor 370 detects that the turntable 140 is rotated approximately 90 degrees in the counterclockwise direction, the microcomputer stops the stepping motor 165 (S3, S4, S5). After that, the magazine drive motor 333 is driven predetermined steps (S6). The microcomputer then drives the stepping motor 165 in the reverse direction. When the photo sensor 370 detects that the turntable 140 is rotated in the clockwise direction to the home position, the microcomputer stops the stepping motor 165 (S7, S8, S9).

If the command is directed to the second magazine 103, the microcomputer drives the stepping motor 165 in the reverse direction. In this embodiment, when the photo sensor 370 detects that the turntable 140 is rotated approximately 90 degrees in the clockwise direction, the microcomputer stops the stepping motor 165 (S10, S11, S12). After that, the magazine drive motor 333 is driven predetermined steps (S13). The microcomputer then drives the stepping motor 165 in the normal direction. When the photo sensor 370 detects that the turntable 140 is rotated in the counterclockwise direction to the home position, the microcomputer stops the stepping motor 165 (S14, S15, S16).

8 [Configuration and Operations of Mis-loading Inhibitor of Tape Cartridge Transport Magazines 103, 104]

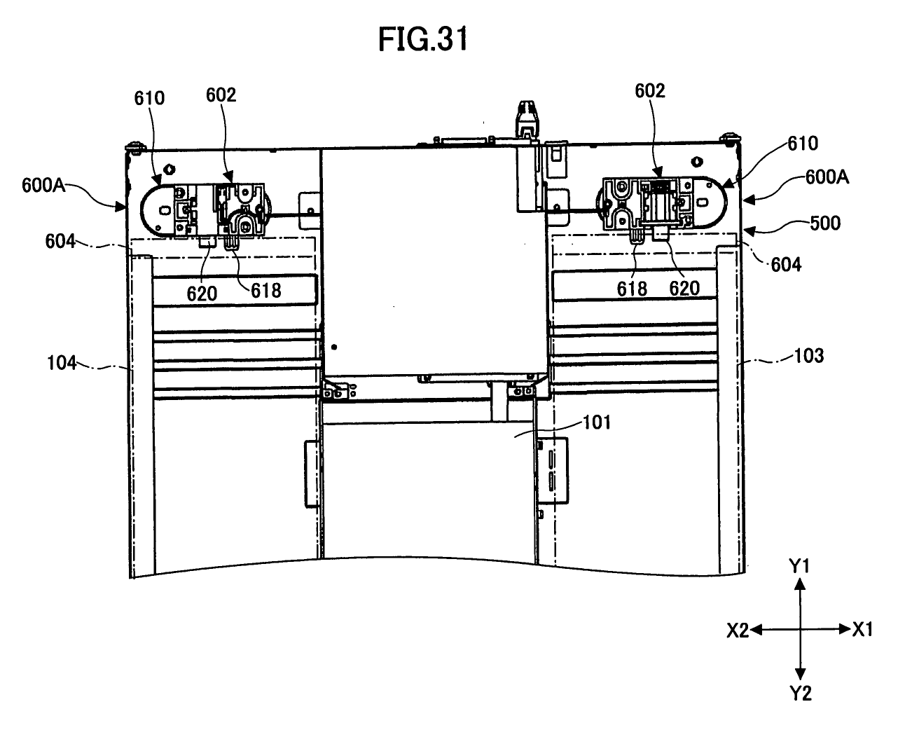

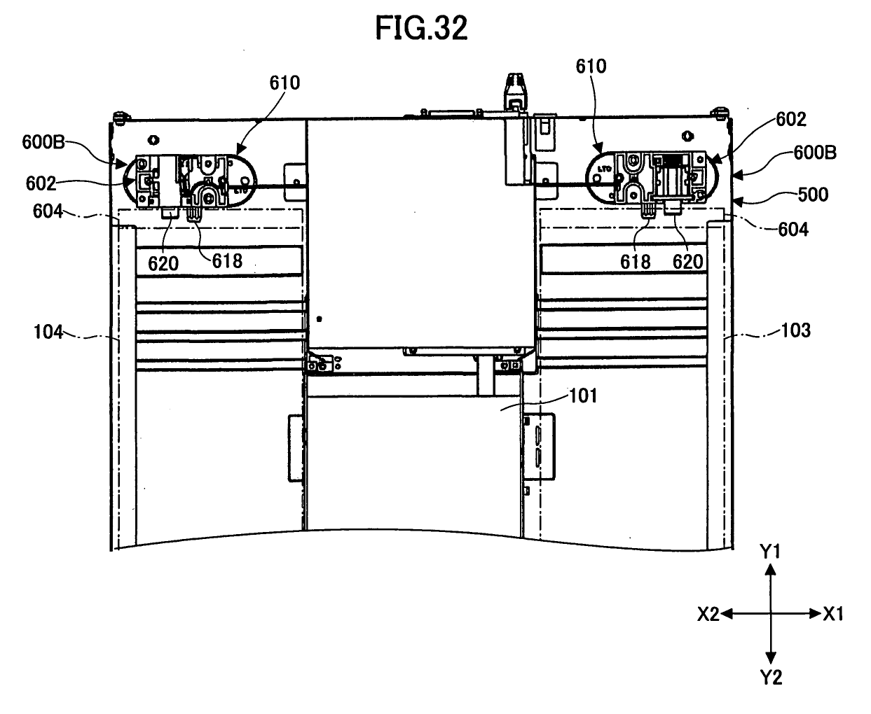

FIG. 31 is a plan view illustrating a mis-loading inhibitor 600A for inhibiting or preventing the tape cartridge transport magazines 103 and 104 from being mis-loaded. FIG. 32 is a plan view illustrating a mis-loading inhibitor 600B for inhibiting or preventing the tape cartridge transport magazines 103 and 104 from being mis-loaded.

The mis-loading inhibitors 600A and 600B are mechanisms for inhibiting or preventing the tape cartridge transport magazines 103 and 104, each containing one or more tape cartridges 10, of a different recording system from being mis-loaded. As used herein, the recording system refers to the type of media drive 101 used in the autoloader 100. For example, each different type of media drive 101 is equipped to accommodate a specific type of media cartridge 10. Stated another way, certain types of media cartridges 10 can be used with certain types of media drives 101, and not with others, which can depend upon the shape, size, model, type of media, age, configuration and/or any other relevant considerations of the media cartridge 10 relative to the media drive 101. The mis-loading inhibitors 600A and 600B each includes a mis-loading inhibitor member 602 secured to the frame 500, and lid members 604 disposed at the ends of the tape cartridge transport magazines 103 and 104. In addition, the mis-loading inhibitors 600A and 600B each changes the directions of the mis-loading inhibitor member 602 and the lid member 604 corresponding to the types of the tape cartridges 10.

As described above, the tape cartridge transport magazines 103 and 104 are configured to transport the tape cartridge containers 401 (see FIG. 2) containing the tape cartridge 10, and plural tape cartridge containers 401 (for example, eight) are connected to the belt 400 therein. Accordingly, the same number of the tape cartridges 10 as the disposed number of the tape cartridge containers 401 can be contained in each of the tape cartridge transport magazines 103 and 104. Also, plural types of the tape cartridges 10 whose size and shape are different are available corresponding to different magnetic recording systems. The tape cartridge container 401 of the present embodiment is configured to selectively store two types of the tape cartridges 10 (hereinafter, referred to as an A type tape cartridge 10A and a B type tape cartridge 10B). In an alternative embodiment, the tape cartridge container 401 of the present embodiment is configured to selectively store greater than or less than two types of the tape cartridges 10.

The disposing directions of the mis-loading inhibitor member 602 and the lid member 604 are changed corresponding to the types of the tape cartridges 10A and 10B; accordingly, which type the tape cartridge 10A or 10B is can be determined only from the disposing directions (shapes) of the mis-loading inhibitor member 602 and the lid member 604. When the disposing directions (A type and B type) are determined in advance, both of the tape cartridges 10A and 10B can be easily handled.

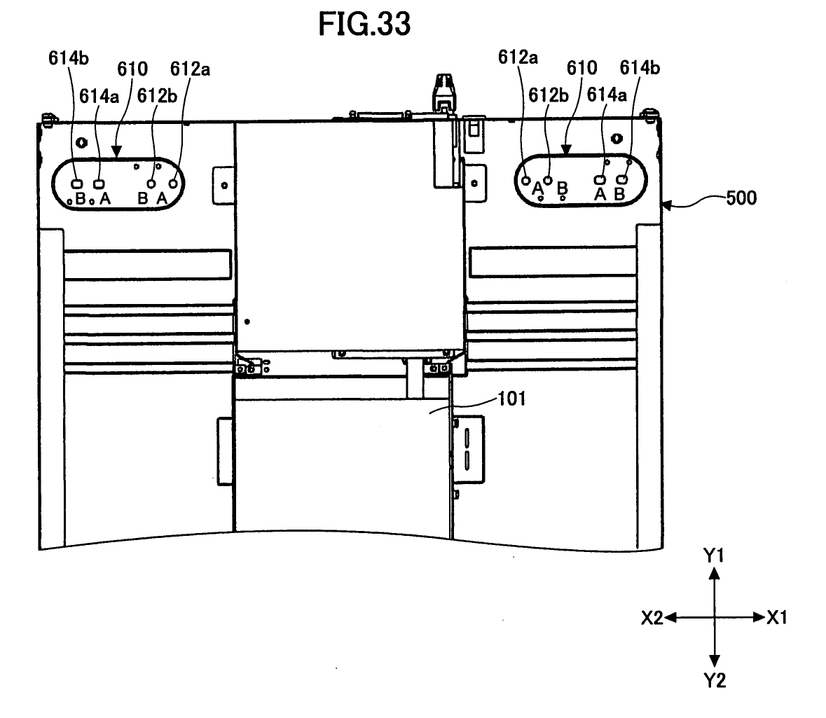

FIG. 33 is a plan view enlarging the upper rear part of the frame 500 before the mis-loading inhibitor members 602 are attached. As shown in FIG. 33, the upper rear part of the frame 500 is positioned at the back of the tape cartridge loading area where the tape cartridge transport magazines 103 and 104 are loaded, and mis-loading inhibitor member attaching sections 610 having an ellipse shape are provided therein. In the mis-loading inhibitor member attaching section 610, positioning holes 612a and 614a corresponding to the tape cartridge 10A and positioning holes 612b and 614b corresponding to the tape cartridge 10B are provided in the X1-X2 direction in line. In one embodiment, the positioning holes 612a and 612b can be circular-shaped holes, and the positioning holes 614a and 614b can be elliptical holes. Alternatively, the shapes of the positioning holes 612a, 612b, 614a, 614b can have different configurations than those shown in FIG. 33.

In this embodiment, the positioning holes 612a and 614a and the positioning holes 612b and 614b are disposed symmetrically in the right region where the tape cartridge transport magazine 103 is loaded and in the left region where the tape cartridge transport magazine 104 is loaded.

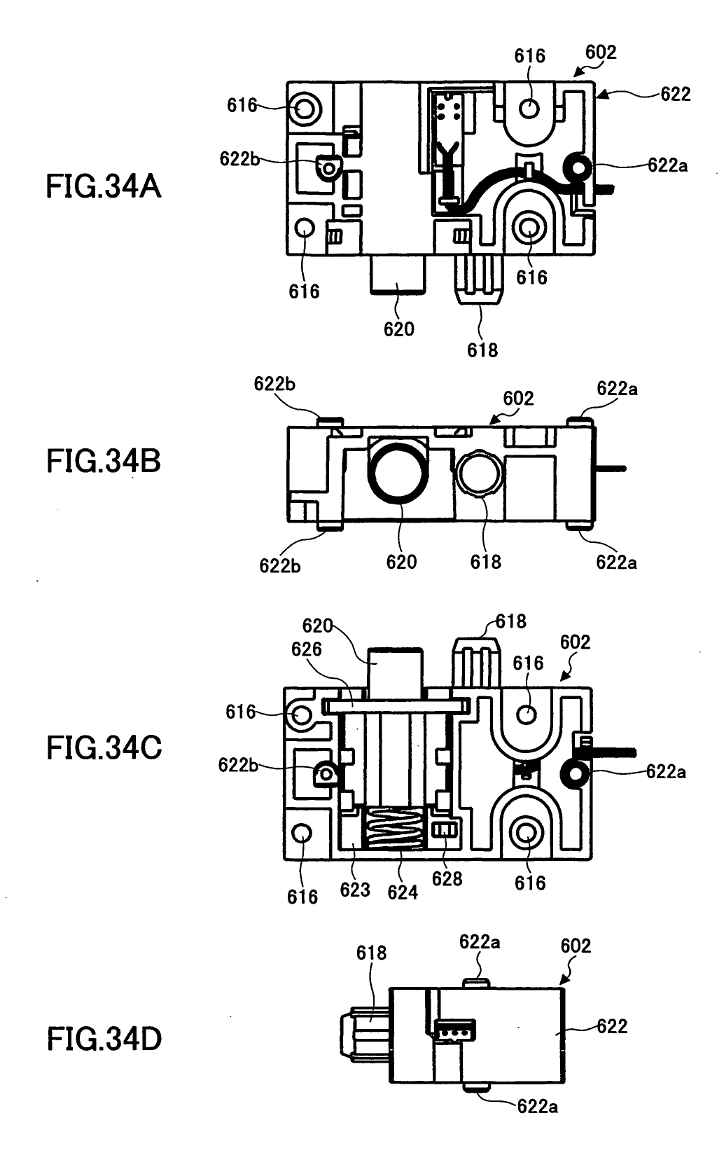

FIGS. 34A-34D illustrate a configuration of the mis-loading inhibitor member 602, wherein FIG. 34A illustrates a plan view, FIG. 34B illustrates a front view, FIG. 34C illustrates a bottom view, and FIG. 34D illustrates a side view. As shown in FIGS. 34A-34D, the mis-loading inhibitor member 602 provides a positioning boss 622a and a positioning boss 622b on the upper face and the bottom face of a main body 622 thereof having a rectangular shape. In this embodiment, the positioning boss 622a is formed as a circle to fit into either one of the positioning hole 612a or 612b having the circular shape. The positioning boss 622b can be formed as a shape other than a circle, and can be larger than the positioning holes 612a and 612b to fit into either one of the positioning holes 614a or 614b having the elliptical shape.

From the upper face to the bottom face of the main body 622, a screw inserted through holes 616 can be used to secure the mis-loading inhibitor member 602 to the mis-loading inhibitor member attaching section 610. From the front face of the main body 622, a first convex section (section to be fitted) 618 and a second convex section (section to be fitted) 620 extend out horizontally. The first convex section 618 is integrated with the main body 622, and is formed to be tapered at its tip end so that the first convex section 618 can easily fit into a fitting hole (described later) of the lid member 604.

The second convex section 620 is assembled in a space 623 formed inside the main body 622 so that the second convex section 620 can slide in the space 623. In the space 623, the second convex section 620 is inserted so as to be able to slide in the Y1-Y2 direction, and is moved by a spring force of a coil spring 624 (moving means) in the Y2 direction (magazine ejecting direction).

The second convex section 620 is inhibited or prevented from jumping out from the main body 622 and its sliding direction is guided by a guide plate 626 secured to the main body 622. Further, in the space 623, a detecting sensor (detecting means) 628 for detecting that the second convex section 620 slides in the Y1 direction against the spring force of the coil spring 624. The detecting sensor 628 is, for example, a photo-interrupter, combining a light emitting element with a light receiving element, and can detect the sliding movement of the second convex section 620 without contact. In this, the second convex section 620 is attached to the space 623 in a manner so that the second convex section 620 is withdrawn into the space 623 by being pressed by the lid member 604 disposed at the tip end of the tape cartridge transport magazine 103 or 104 when the tape cartridge transport magazine 103 or 104 is loaded. This will be described below in detail.

The detecting sensor 628 is connected to the motor control circuit 410. Therefore, when the detecting sensor 628 detects that the second convex section 620 slides in the Y1 direction so that the second convex section 620 is pressed by the lid member 604, the motor control circuit 410 recognizes that the tape cartridge transport magazine 103 or 104 is properly loaded into the autoloader 100. When the second convex section 620 is not pressed by the lid member 604, a signal from the detecting sensor 628 does not change; consequently, the motor control circuit 410 can recognize that the type of the tape cartridge transport magazine is different from the normal tape cartridge transport magazine 103 or 104, and is therefore not properly loaded.

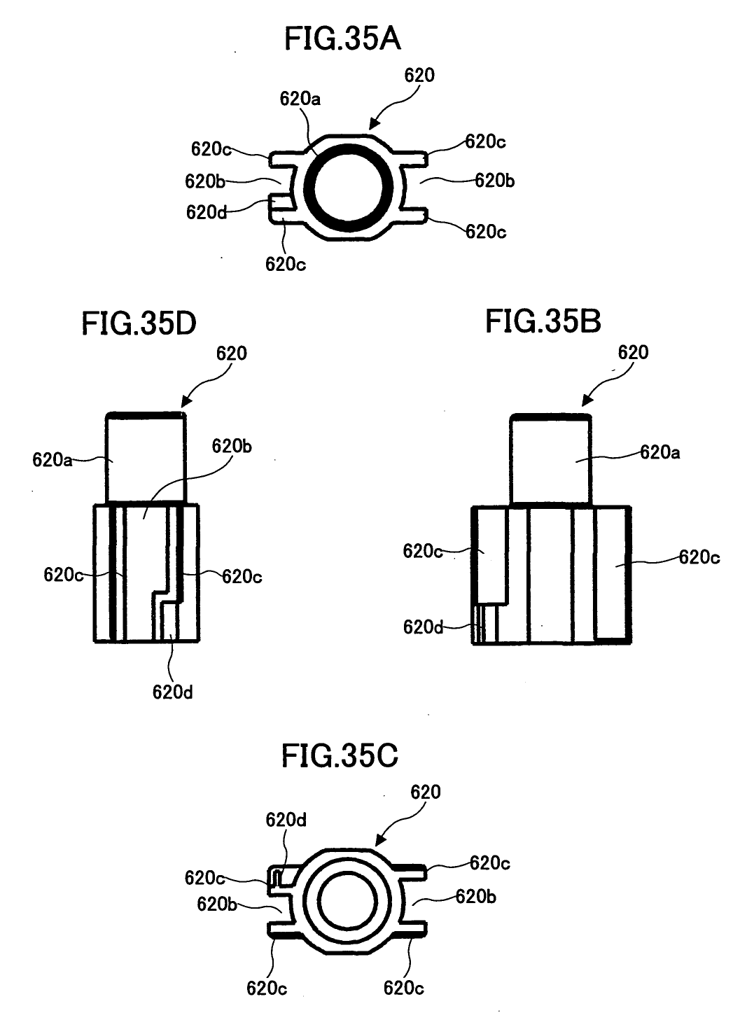

FIGS. 35A-35D illustrate one embodiment of the second convex section 620. The configuration of the second convex section 620 can vary depending upon the design requirements of the autoloader 100 and the tape cartridge transport magazines 103, 104. FIG. 35A illustrates a front view, FIG. 35B illustrates a plan view, FIG. 35C illustrates a back view, and FIG. 35D illustrates a side view. In the embodiment shown in FIGS. 35A-35D, the second convex section 620 includes a cylinder section 620a sticking out of the main body 622, guide grooves 620b fitting to guiding protrusions (not shown) in the space 623, collar sections 620c extending in the Y1-Y2 direction to form the guide grooves 620b, and a plate-shaped protrusion 620d rising at the rear part of one of the collar sections 620c. The plate-shaped protrusion 620d is formed at a position where the detecting sensor 628 passes through, and is a plate to be detected which blocks light between the light emitting element and the light receiving element of the detecting sensor 628 when the second convex section 620 is moved in the Y1 direction.

Accordingly, when the plate-shaped protrusion 620d is moved to a light blocking position, the output from the light receiving element in the detecting sensor 628 is changed to a lower level. Thus, when the signal level of the detecting sensor 628 is lowered, the motor control circuit 410 can detect that the tape cartridge transport magazine 103 or 104 is loaded.

In a case where the tape cartridge transport magazine 103 or 104 is the A type, the positioning bosses 622a and 622b (FIG. 34A) of the mis-loading inhibitor member 602 are fitted into the positioning holes 612a and 614a (FIG. 33) for the A type of the mis-loading inhibitor member attaching section 610. With this, the mis-loading inhibitor member attaching section 610 is attached to the position for the A type.

In a case where the tape cartridge transport magazine 103 or 104 is the B type, the positioning bosses 622a and 622b (FIG. 34A) of the mis-loading inhibitor member 602 are fitted into the positioning holes 612b and 614b (FIG. 33) for the B type of the mis-loading inhibitor member attaching section 610. With this, the mis-loading inhibitor member attaching section 610 is attached to the position for the B type.

In the present embodiment, when FIG. 31 is compared with FIG. 32, the attaching position of the mis-loading inhibitor member 602 is the inner side in the tape cartridge autoloader 100 (at the near side to the tape drive 101) in case of the A type, and is the outer side in case of the type B. Further, in the present embodiment, the mis-loading inhibitor member 602 can be disposed in the side where the tape cartridge transport magazine 103 is loaded and in the side where the tape cartridge transport magazine 104 is loaded; therefore, when the attaching directions of the mis-loading inhibitor member 602 are set to opposite directions in the up and down directions (for example, the directions shown in FIGS. 34A and 34C), the present embodiment can be applied to both of the types A and B. Consequently, in this embodiment, there is no need to separately manufacture the mis-loading inhibitor member 602 for the different sides; thus, the manufacturing cost of the mis-loading inhibitor member 602 can be lowered.

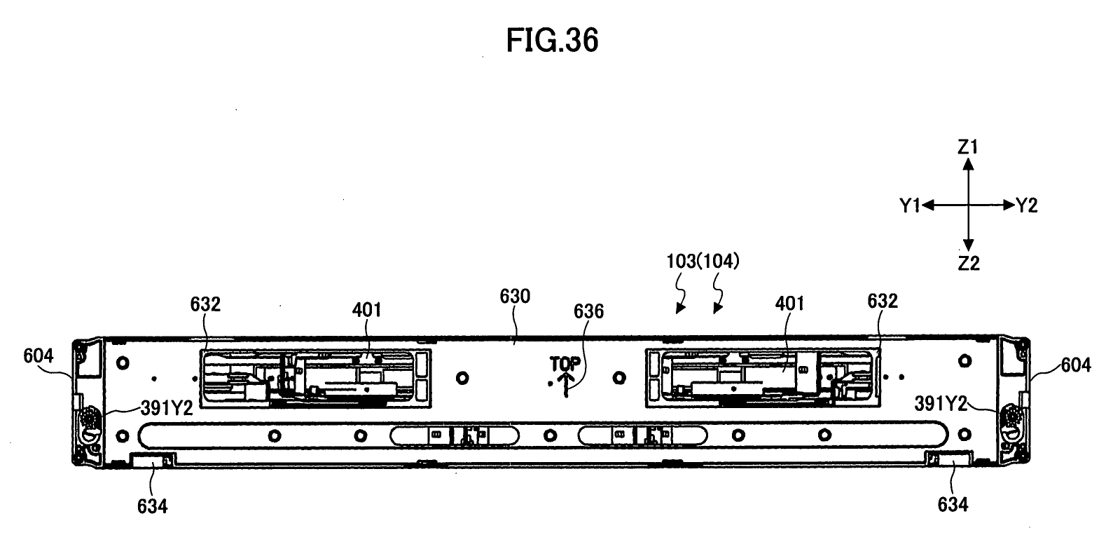

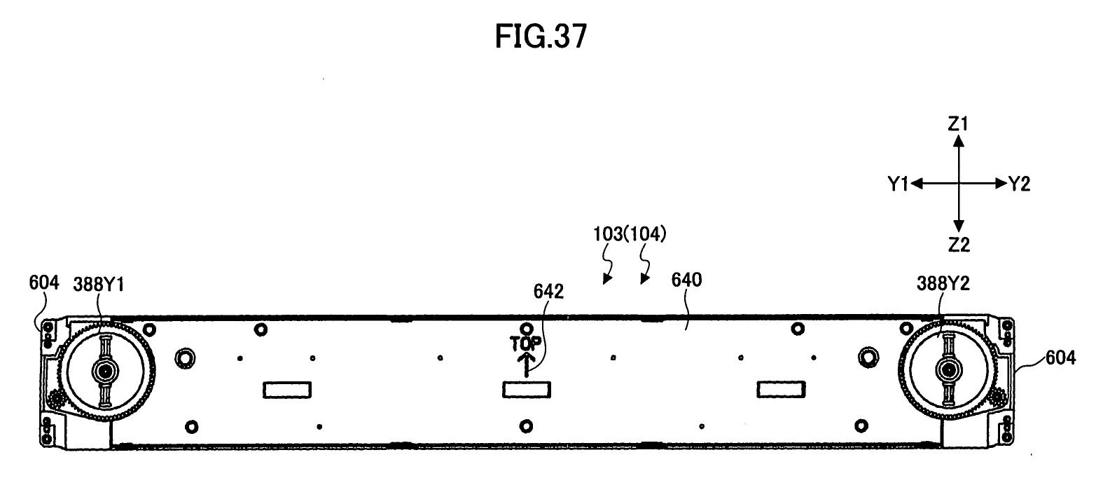

FIG. 36 is a side view illustrating an inner side of the tape cartridge transport magazines 103 and 104. FIG. 37 is a side view illustrating an outer side of the tape cartridge transport magazines 103 and 104. As shown in FIGS. 36 and 37, the lid members 604 are attached to both ends of the tape cartridge transport magazines 103 and 104. In this embodiment, the tape cartridge transport magazines 103 and 104 have the same configuration and are configured to correspond to either one of the left or right attaching position of the frame 500 (FIG. 1) by setting either end of both ends to the front end.

The tape cartridge transport magazines 103 and 104 have a mechanism that transports plural tape cartridge containers 401 therein, and an inner panel 630 is attached to one side face thereof and an outer panel 640 is attached to the other side face thereof.

In the inner panel 630, two openings 632 for inserting/ejecting the tape cartridge 10 are provided, further the openings 391Y2 for inserting and engaging the drive gears 313X1 and 313X2 are provided at the both ends thereof (see FIGS. 13-19). Therefore, in one embodiment, one of the two openings 632 and one of the openings 391Y2 provided in the inner panel 630 positioned at the front end are used, and the others positioned at the back end are not used. In an alternative embodiment (not shown), the autoloader 100 can be configured so that both openings 632 and/or the opening 391Y2 at the back end can also be used.

In addition, locking concave sections 634 are provided at the lower parts adjacent to both ends of the inner panel 630. When the tape cartridge transport magazines 103 and 104 are attached to predetermined attaching positions of the frame 500, the locking concave sections 634 are fitted into locking levers 700 (see FIGS. 4 and 5) extending from the side faces of the main module 110. Consequently, the tape cartridge transport magazines 103 and 104 are held at predetermined positions so that the locking levers 700 are fitted into the locking concave sections 634, and assume a state where the tape cartridge transport magazines 103 and 104 are inhibited or prevented from being ejected.

At corresponding ends of the outer panel 640, the large-diameter gear members 388Y1 and 388Y2 are exposed, and an arrow 642 is formed to indicate the upper direction at the center of the outer panel 640. In addition, an arrow 636 is formed to indicate the upper direction at the center of the inner panel 630. Therefore, since the tape cartridge transport magazines 103 and 104 have the above-described symmetric configuration, the user can properly load the tape cartridge transport magazines 103 and 104 by confirming the appropriate direction of arrows 636 and 642.

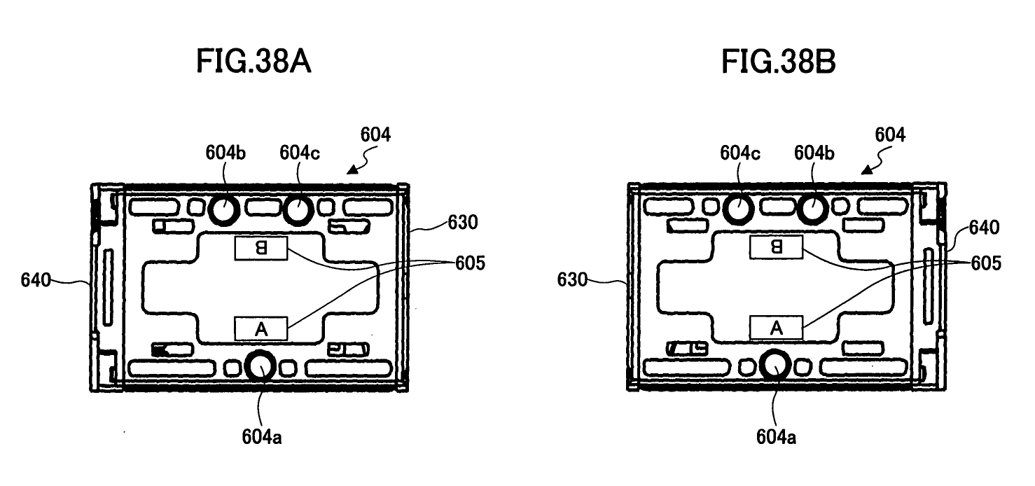

FIGS. 38A-38B illustrate the directions of the lid member 604 when the tape cartridge 10A being the A type is used. FIG. 38A is a view in which the lid member 604 is attached to one end of the tape cartridge transport magazines 103 and 104, and FIG. 38B is a view in which the lid member 604 is attached to the other end of the tape cartridge transport magazines 103 and 104.

As shown in FIGS. 38A and 38B, the lid member 604 provides regulating holes 604a through 604c (fitting sections) for inhibiting the tape cartridge transport magazines 103 and 104 from being mis-loaded. In addition, at the center of the lid member 604, letters 605, for example, “A” and “B” showing the types of the tape cartridges 10 are formed in the vertical opposite directions. When the letter 605 on the lid member 604 is in an upright position, the letter shows the type of the tape cartridge 10 to be loaded.

Therefore, when the tape cartridge 10A is used, the lid members 604 are attached to the tape cartridge transport magazines 103 and 104 in a manner so that the regulating hole 604a is positioned at the lower part and the other regulating holes 604b and 604c are positioned at the upper parts. Consequently, when the lid member 604 is attached in this direction (A type direction), the regulating hole 604a faces the first convex section 618 of the mis-loading inhibitor member 602 secured to the frame 500. In this case, as shown in FIG. 31, the mis-loading inhibitor member 602 is attached to the A type position (inner position) of the mis-loading inhibitor member attaching section 610.

In a case where the tape cartridge transport magazines 103 and 104 of the B type are mis-loaded, since the mis-loading inhibitor member 602 is attached to the A type position (inner position), the position of the regulating hole 604a does not match the position of the first convex section 618, so that the tape cartridge transport magazines 103 and 104 of the B type cannot be inserted into the predetermined loading positions where the locking levers 700 fit into the locking concave sections 634, and are inhibited or prevented from being loaded. Consequently, the loading of the tape cartridge transport magazines 103 and 104 of the B type whose recording system is different from that of the main module 110 is inhibited or prevented.

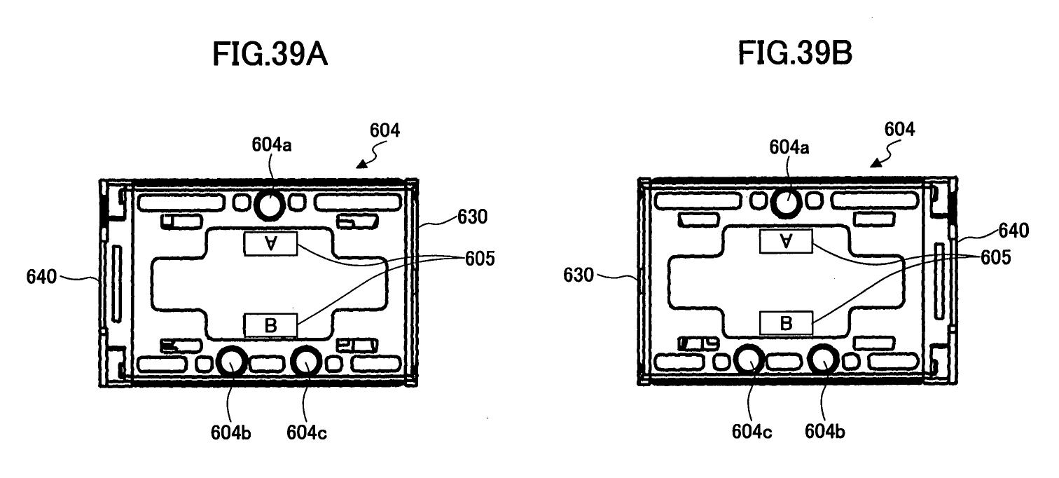

FIGS. 39A-39B illustrate the directions of the lid member 604 when the tape cartridge 10B being the B type is used. FIG. 39A is a view in which the lid member 604 is attached to one end of the tape cartridge transport magazines 103 and 104, and FIG. 39B is a view in which the lid member 604 is attached to the other end of the tape cartridge transport magazines 103 and 104.

As shown in FIGS. 39A and 39B, when the tape cartridge 10B is used, the lid members 604 are attached to the tape cartridge transport magazines 103 and 104 in a manner so that the regulating holes 604b and 604c are positioned at the lower parts and the other regulating hole 604a is positioned at the upper part. Consequently, when the lid member 604 is attached in this direction (B type direction), either one of the regulating hole 604b or 604c faces the first convex section 618 of the mis-loading inhibitor member 602 secured to the frame 500. In this case, as shown in FIG. 32, the mis-loading inhibitor member 602 is attached to the B type position (outer position) of the mis-loading inhibitor member attaching section 610. In case of the tape cartridge transport magazine 103 which is loaded in the right side from the perspective of FIG. 1, for example, the regulating hole 604b positioned at the right side fits into the first convex section 618 of the mis-loading inhibitor member 602. In case of the tape cartridge transport magazine 104 which is loaded in the left side from the perspective of FIG. 1, for example, the regulating hole 604b positioned at the left side fits into the first convex section 618 of the mis-loading inhibitor member 602.

In a case where the tape cartridge transport magazines 103 and 104 of the A type are mis-loaded, since the mis-loading inhibitor member 602 is attached to the B type position (outer position), the position of the regulating hole 604a does not match the position of the first convex section 618, so that the tape cartridge transport magazines 103 and 104 of the A type are inhibited from being inserted into the predetermined loading positions where the locking levers 700 fit into the locking concave sections 634, and are inhibited or prevented from being loaded. Consequently, the loading of the tape cartridge transport magazines 103 and 104 of the A type whose recording system is different from that of the main module 110 is inhibited or prevented.

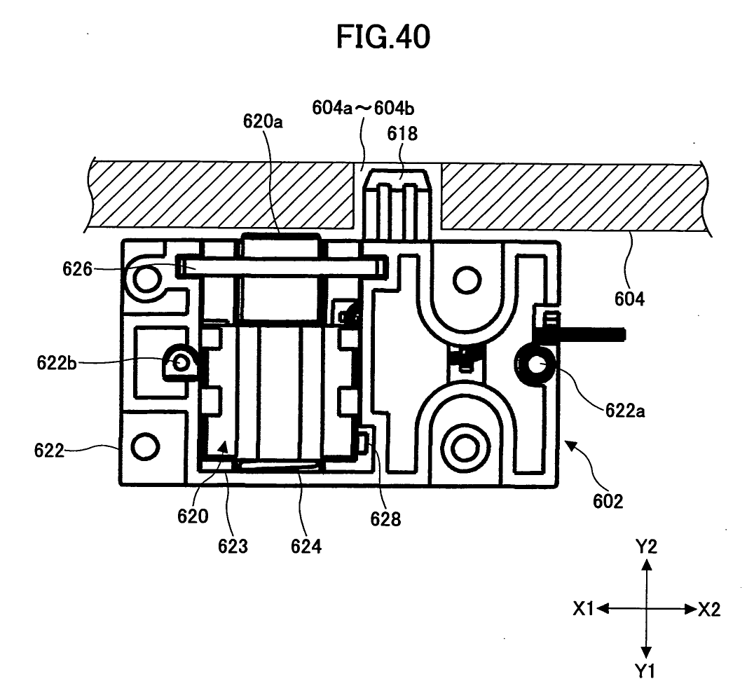

FIG. 40 illustrates a fitting state between the mis-loading inhibitor member 602 and the lid member 604. As shown in FIG. 40, when the directions of the mis-loading inhibitor member 602 and the lid member 604 are set to the A type, or the directions of the mis-loading inhibitor member 602 and the lid member 604 are set to the B type; the tape cartridge transport magazines 103 and 104 can be normally loaded in the loading positions by that the position of any one of the regulating holes 604a through 604c matches the position of the first convex section 618 of the mis-loading inhibitor member 602.

As described above, when the tape cartridge transport magazines 103 and 104 are properly loaded, the second convex section 620 is pressed in the inserting direction (Y1 direction) so that the cylinder section 620a abuts on the lid member 604 and slides in the space 623 against the spring force of the coil spring 624. When the plate-shaped protrusion 620d of the second convex section 620 reaches a position that blocks light of the detecting sensor 628, the motor control circuit 410 recognizes that tape cartridge transport magazines 103 and 104 are properly loaded by a signal from the detecting sensor 628.

In addition, the tape cartridge transport magazines 103 and 104 loaded at the predetermined loading positions are held at the predetermined loading positions so that the locking levers 700 (see FIGS. 4 and 5) extending from the left and right sides of the main module 110 (from the perspective of FIG. 1) fit into the locking concave sections 634. When an ejecting operation is performed, the locking levers 700 are withdrawn into the inside of the main module 110; therefore, the tape cartridge transport magazines 103 and 104 are expelled in the ejecting directions by the spring force of the coil spring 624 that presses the second convex section 620 in the Y2 direction. With this, the user can visually recognize that the tape cartridge transport magazines 103 and 104 are ejected.

The present application is based on Japanese Priority Application No. 2005-267533 filed on Sep. 14, 2005, with the Japanese Patent Office, the entire contents of which are hereby incorporated by reference.

While the particular autoloader 100 as herein shown and disclosed in detail is fully capable of obtaining the objects and providing the advantages herein before stated, it is to be understood that it is merely illustrative of various embodiments of the invention. No limitations are intended to the details of construction or design herein shown other than as described in the appended claims.

What is claimed is:

1. A media cartridge autoloader that provides a media cartridge transport magazine which contains a plurality of media cartridges, a frame which holds the media cartridge transport magazine, and a media drive into which an arbitrary one of the media cartridges selected from the plural media cartridges being contained in the media cartridge transport magazine, is moved and loaded,
wherein a lid member having a shape corresponding to the type of the media cartridge is changeably attached to the end of the media cartridge transport magazine, and a mis-loading inhibitor member having a shape corresponding to the lid member is changeably attached to the frame.

2. The media cartridge autoloader as claimed in claim 1,
wherein the lid member includes a fitting section at a position corresponding to the type of the media cartridge, and the mis-loading inhibitor member includes a section to be fitted into the fitting section at a position corresponding to the position of the fitting section.

3. The media cartridge autoloader as claimed in claim 2,
wherein the lid member includes a plurality of the fitting sections, and the positions of the fitting sections opposing the mis-loading inhibitor member are changed by changing the direction for attaching the lid member to the media cartridge transport magazine.

4. The media cartridge autoloader as claimed in claim 2,
wherein the mis-loading inhibitor member includes a plurality of the sections to be fitted into the fitting sections, and the positions of the sections to be fitted into opposing the lid member are changed by changing the direction for attaching the mis-loading inhibitor member to the frame.

5. The media cartridge autoloader as claimed in claim 4,
wherein the mis-loading inhibitor member includes a first section to be fitted into the fitting section, a second section that moves by being pressed by the lid member, and a moving member that moves the second section in the direction opposite to the inserting direction of the media cartridge transport magazine.

6. The media cartridge autoloader as claimed in claim 5,
wherein the mis-loading inhibitor member includes a detecting unit for detecting that the second section is moved by being pressed by the lid member.

7. The media cartridge autoloader as claimed in claim 6,
wherein the detecting unit detects that the type of the media cartridge transport magazine is normal when the second section is pressed by the lid member, and detects that the type of the media cartridge transport magazine is abnormal when the second section is not pressed by the lid member.

8. A media cartridge autoloader for use with first and second types of media cartridges, the media cartridge autoloader comprising:
a media drive that is adapted for use with only one of a first type of media cartridge and a second type of media cartridge;
a removable media cartridge transport magazine that releasably stores either the first type of media cartridge or the second type of media cartridge for use in the media drive, the media cartridge transport magazine including a lid member having a configuration that depends upon the type of the media cartridge stored in the media cartridge transport magazine; and
a mis-loading inhibitor member having a configuration that depends upon the type of media cartridge adapted for use with the media drive, the mis-loading inhibitor member only allowing full engagement with the lid member to allow full loading of the media cartridge transport magazine into the autoloader when the type of media cartridge stored in the media cartridge transport magazine is the same as the type of media cartridge adapted for use with the media drive.

9. The media cartridge autoloader as claimed in claim 8,
wherein the configuration of the mis-loading inhibitor inhibits full engagement with the lid member when the type of media cartridge stored in the media cartridge transport magazine is not adapted for use with the media drive.

10. The media cartridge autoloader as claimed in claim 8,
further comprising a frame that receives the media cartridge transport magazine.

11. The media cartridge autoloader as claimed in claim 10,
wherein the mis-loading inhibitor member is secured to the frame.

12. The media cartridge autoloader as claimed in claim 11,
wherein the media drive is secured to the frame.

13. A method for configuring a media cartridge autoloader, the method comprising the steps of:
providing a media drive that is adapted for use with only one of a plurality of different types of media cartridges;
configuring a lid member of a media cartridge transport magazine adapted to store one of the plurality of media cartridges so that the configuration depends upon the type of media cartridge adapted to be stored in the media cartridge transport magazine; and
configuring a mis-loading inhibitor member of the media cartridge autoloader to fully engage the lid member to allow full loading of the media cartridge transport magazine into the media cartridge autoloader only when the type of media cartridge stored in the media cartridge transport magazine is the same as the type of media cartridge adapted for use in the media drive.
